(19) United States
(12) Patent Application Publication
(10) Pub. No.: US 2015/0088774 A1
(43) Pub. Date: Mar. 26, 2015

(54) PLATFORM FOR GENERATING PERSONALIZED CAREER PATHWAYS

(71) Applicant: Viridis Learning Inc., New York, NY (US)

(72) Inventor: Felix Ortiz, III, New York, NY (US)

(21) Appl. No.: 14/494,539

(22) Filed: Sep. 23, 2014

Related U.S. Application Data
(63) Continuation of application No. PCT/US14/57058, filed on Sep. 23, 2014.
(60) Provisional application No. 61/881,312, filed on Sep. 23, 2013.
(60) Provisional application No. 62/025,467, filed on Jul. 16, 2014.

(51) Int. Cl. G06Q 10/10

(52) U.S. Cl. CPC G06Q 10/1053
USPC 705/321

(57) ABSTRACT

The disclosure provides for generating an adaptive career pathway for an individual. An apparatus is provided that includes at least one processing unit to: (A) receive data indicative of two or more of an educational level, a skill level, a personality metric, a residence location, a score in an educational course, a score in a vocational course, a job location, and a skill set selected by the individual; (B) compute an assessment vector associated with the individual based on the received data; (C) perform a GAP analysis to compare the assessment vector to a database of job taxonomy vectors, wherein each job taxonomy vector comprises data indicative of deconstruction parameters associated with a specified job; and (D) classify the individual, based on the GAP analysis, according to at least one of a coursework recommendation, a career pathway recommendation, and an employability score.

### CROSS-REFERENCE TO RELATED PATENT APPLICATIONS

This application is a continuation of international application no. PCT/US14157058, filed Sep. 23, 2014, entitled “PLATFORM FOR GENERATING PERSONALIZED CAREER PATHWAYS,” which is hereby incorporated herein by reference in its entirety. This application also claims priority to U.S. provisional application no. 61/881,312, filed Sep. 23, 2013, entitled “PLATFORM FOR SKILLS ASSESSMENT, CERTIFICATION TRAINING AND JOB MATCHING,” and U.S. provisional application No. 62/025,467, filed Jul. 16, 2014, entitled “PLATFORM FOR GENERATING PERSONALIZED CAREER PATHWAYS,”each of which is hereby incorporated herein by reference in its entirety.

### BACKGROUND OF THE DISCLOSURE

Some existing online tools for students merely provide a listing of available courses at an institution. However, such tools provide little to no guidance to the student as to a potential career pathway or to administrators as to the progress of the student.

### SUMMARY OF THE DISCLOSURE

In view of the foregoing, systems, apparatus and methods are provided for generating personalized career pathways for an individual or group of individuals. The example pathways generated according to the systems, apparatus and methods disclosed herein can be used to provide skills assessment, recommendations for certificate training, and/or job matching.

An example apparatus, system and method is provided for generating an adaptive career pathway for an individual, In an example, the apparatus or system can include at least one communication interface, at least one memory to store processor-executable instructions, and at least one processing unit, communicatively coupled to the at least one communication interface and the at least one memory. Upon execution of the processor-executable instructions, the at least one processing unit can perform a method comprising: (A) receiving data indicative of two or more of an educational level, a skill level, a personality metric, a residence location, a score in an educational course, a score in a vocational course, a job location, and a skill set selected by the individual, (B) computing an assessment vector associated with the individual based on the received data, (C) performing a GAP analysis to compare the assessment vector to a database of job taxonomy vectors, wherein each job taxonomy vector comprises data indicative of deconstruction parameters associated with a specified job, and (D) classifying the individual, based on the GAP analysis, according to at least one of a coursework recommendation, a career pathway recommendation, and an employability score.

In an example, the at least one processor can be configured to control the at least one communication interface to transmit a result of the classification, and/or control the memory to store the result of the classification.

An example apparatus, system and method can be configured to present a graphical user interface. The graphical user interface (GUI) can be configured for facilitating generation of an adaptive career pathway for an individual. The GUI can include two or more graphical interface pages arranged in a hierarchical format or a navigable format. The two or more graphical interface pages can include: (A) at least one graphical interface page to receive input data indicative of two or more of an educational level, a skill level, a personality metric, a residence location, a score in an educational course, a score in a vocational course, a job location, and a skill set selected by the individual; and (B) at least one graphical interface page to display data indicative of a classification of the individual according to at least one of a coursework recommendation, a career pathway recommendation, and an employability score. The classification can be based on a GAP analysis that compares (i) an assessment vector associated with the individual, computed based on the received data, and (ii) a database of job taxonomy vectors, each job taxonomy vector comprising data indicative of deconstruction parameters associated with a specified job.

An example apparatus, system and method is provided for generating an adaptive career pathway for an individual. In an example, the apparatus or system can include at least one communication interface, an assessment module to compute an assessment vector associated with the individual based on received data, the received data comprising data indicative of two or more of an educational level, a skill level, a personality metric, a residence location, a score in an educational course, a score in a vocational course, a job location, and a skill set selected by the individual, an analysis module to apply a GAP analysis to compare the assessment vector to a database of job taxonomy vectors, wherein each job taxonomy vector comprises data indicative of deconstruction parameters associated with a specified job, and a classification module to classify the individual, based on the GAP analysis, according to at least one of a coursework recommendation, a career pathway recommendation, and an employability score.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

The foregoing and other aspects, examples, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1 shows an example of a system module, according to the principles herein.

FIG. 2 shows a block diagram for an example implementation of a system and apparatus that includes a system module, according to the principles herein.

FIG. 3 shows an example of a computer system, according to the principles herein.

FIG. 4 shows a flowchart of an example system, method and apparatus for generating an adaptive career pathway for an individual, according to the principles herein.

FIGS. 5 and 6 show flow-charts of different example implementations, according to the principles herein.

FIGS. 7-9 show examples of user interfaces, according to the principles herein.

FIG. 10 shows a block diagram of an example platform, according to the principles herein.

FIG. 11 shows an example output of a system or apparatus, according to the principles herein.

FIG. 12 shows an example of industry and workplace competencies that an individual candidate can be trained in, according to the principles herein.

FIG. 13 shows an example of communication links that can be established, according to the principles herein.

FIG. 14 shows a comparison of the results that can be derived using the example systems, according to the principles herein.

FIGS. 15-17 show non-limiting example user interfaces, according to the principles herein.

FIGS. 18-31 show other non-limiting example user interfaces, according to the principles herein.

FIGS. 32-51 show other non-limiting example user interfaces, according to the principles herein.

### DETAILED DESCRIPTION

It should be appreciated that all combinations of the concepts described in greater detail below (provided such concepts are not mutually inconsistent) are contemplated as being part of the inventive subject matter disclosed herein. It also should be appreciated that terminology explicitly employed herein that also may appear in any disclosure incorporated by reference should be accorded a meaning most consistent with the particular concepts disclosed herein.

Following below are more detailed descriptions of various concepts related to, and embodiments of, inventive methods, apparatus and systems for generating personalized career pathways for individuals. The example career pathways generated according to the systems and methods disclosed herein can be used to provide skills assessment, recommendations for certificate training, and/or job matching, Also provided below are detailed descriptions of various concepts related to, and embodiments of, inventive methods, computer-readable media, and systems for performing skills assessment based on user data, certification training and job matching. It should be appreciated that various concepts introduced above and described in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

The disclosure relates to systems, methods and apparatus that are used for generating a personalized career pathway for an individual. The example career pathway can include at least one of a skills assessment of the individual, a recommendation of certificate training for the individual, and job matching.

Example systems, methods and computer-readable media described herein provide an example skills development system that can be implemented to provide learning and building blocks along a delineated career pathway. The example systems, methods and computer-readable media can be implemented to facilitate training and certification of the middle-skill workforce,

An example system, method and computer-readable media according to the principles described herein implements one or more algorithms (and associated methods) that take as input data on a user and generate an adaptive career pathway based on the data.

An example system, method and computer-readable media according to the principles described herein implements one or more algorithms (and associated methods) that facilitates matching of a job or other employment opportunity to a user that is a job seeker.

The example algorithms (and associated methods) can be configured specifically to each different job sector, each different location or region where the user is located, and the differing skills level of the user, to perform the skills assessment, certification training and job matching. For example, certain types of job opportunities or job types may vary by geographic location, including zip code.

An example system, method and computer-readable media described herein provide an integrated collection of programs and services intended that can be implemented to develop a user's core academic, technical, and employability skills. Skills-based competency training is provided via a platform that can be accessed using any of a number of different types of computing devices, including any of a desktop computer, a smartphone (such as but not limited to an Phone®, a BlackBerry®, or an Android-based smartphone), a tablet, a slate, an electronic book (e-book), an electronic-reader (e-reader), a digital assistant, or other electronic reader or hand-held, portable, or wearable computing device, or any other equivalent device, including an Xbox®, a Wii®, or other game system(s). This allows a user continual opportunities to access the learning, certification and job matching tool, e.g., whether they are on a mobile phone or a desktop,

The example systems, methods, and computer-readable media herein can be configured to provide the skills assessment, certification training and job matching in various industry clusters, such as but not limited to:
a) Construction
b) Manufacturing/Logistics/Transportation
c) Hospitality
d) Facilities Management
e) Retail, Customer Service, Grocery, Restaurant & Food Service
f) Automotive & Industrial Machine Maintenance
g) Health
h) Information Technology

Using an example system, method and computer-readable media, a user can gain specialization in, as non-limiting examples, residential concrete specialization, advanced residential construction supervisor, energy management and controls, and residential construction superintendent.

The example systems, methods and computer-readable media implement algorithms for certification training, The certification training is developed based on the standards set by trade associations and their education institutes, coupled with certification organizations, The certification training includes courseware, according to industry standards, across multiple industries that leads to certification of the users' skills. In an example, the certification training is centered on knowledge, skills and abilities (KSAs) beginning at the foundational workplace competency level, through industry wide technical competencies up to and including industry sector technical competencies.

As non-limiting examples, users may be members of the population that may be underserved in the educational landscape, including from a diverse set of community based organizations, veterans' services groups and community colleges.

As non-limiting examples, the example systems, methods and computer-readable media include:
Module to provide user-configured content and framework
Module to apply an example match/fit taxonomy system to user data
Simplified user interface

The example systems, methods, and computer-readable media according to the principles described herein that can be implemented, e.g., to assess the skills of a user, develop a coursework to facilitate certification for additional or enhanced skills training, and perform job matching.

An example user interface is provided that can be used for input of user data. Non-limiting examples of user data includes educational level, personality factors, residence location, interests.

The example systems, methods, and computer-readable media include a skills assessor that can be implemented to perform the skill assessment based on user data. For example, user data can be analyzed to assess a user according to metrics for, e.g., cultural competency, vocational preparation, and/or base skills level.

The example systems, methods, and computer-readable media include a pathway generator that can be implemented to create a career recommendation pathway based on the output of the skills assessment, guide a user to user-configured content on the platform that is based on the standards set by trade and industry associations. Following the user-configured content can equip a user to undertake the credentialing (certification) requirements of a trade or industry organization. For example, a user may obtain a certification from the trade or industry organization.

Each user can be given a uniquely-configured career recommendation pathway, given that not all users would start everyone at beginner. The career pathway recommendation is developed based on a personalized evaluation of a user's background and preparation, in an example, the career pathway recommendation can be an adaptive career pathway. Based on the user's progress through the competency testing of the coursework, the career pathway recommendation can be adapted to the user's circumstances (such as location), skills and knowledge.

The example systems, methods, and computer-readable media include a training monitor that can be used to provide an evaluation of a user's progress through the coursework based on the certification being pursued. The training monitor uses as input information such as but not limited to the score received by a user in a course, the evaluation of the user by one or more mentors, and the evaluation (such as a ranking) from any vocational training taken during the coursework.

Based on the user data, example systems, methods, and computer-readable media can be implemented to determine an employability score for the user using an employability score generator. The employability score can be used to provide an indication of a user's compatibility to be matched to a job type based on a job metric computed for that job type. The employability may be computed prior to and/or after a user performs any one or more courses according to the certification training.

In an example, a first employability score may be completed prior to or during a user undergoing certification training, and a second employability score may be computed after a user completes the certification training.

The example systems, methods, and computer-readable media also provide for classification of job types and job opportunities from potential employers. The input can include a description of the job, the skills certification required, the culture of the workplace, and the amount of baseline experience preferred. The input can be obtained from the potential employer, from a placement agency, or from other source. The input is analyzed to classify the potential job opportunity or job type according to a metric.

The example systems, methods, and computer-readable media also provides for matching a user to a portal job type or job opportunity based on, e.g., skills training and/or certification skill obtained from pursuing the provided coursework. An example match/fit taxonomy system can be performed using one or more example modules based on the user data. The example match/fit taxonomy facilitates classification of a job opportunity or job type according to a metric that can be compared to the employability score. The example match/fit taxonomy system provides a conceptual framework for discussion, analysis, and/or information retrieval about many different job opportunities or job types. For example, the module for applying the example match/fit taxonomy system can be implemented to classify each job opportunity or job type according to specified elements of a group, such as based on required skills certification, educational background, experience level, or other factors. The example match/fit taxonomy system can also classify the any different job opportunities or job types into subgroups according to distinctions among the many different job opportunities or job types.

The example systems, methods, and computer-readable media provide a user with a platform that can be used to provide the user with skills and/or certification training, provide a display of the user's experience, skills and preparation, and to match the user to potential job opportunities or job types.

In various non-limiting examples, systems, methods, and computer-readable media include one or more modules that can be implemented to perform procedures according to algorithms (and related systems, apparatus and methods to execute the algorithms), such as but not limited to one or more of:
1. Skills assessment. In this example, the input is data indicative of the user info, and the output is coursework recommendation, including a course curriculum, and/or a career pathway recommendation, and/or an employability score. The coursework may be according to one or more certifications from a trade or industry association. A user may follow the coursework or career pathway according to the recommendation. The user may also use the platform to take other coursework outside of the coursework or career pathway recommendation.
2. Monitoring and evaluating user progress through coursework. The monitoring is used to assess the user's progress, learning levels, and facility with the subject matter of a course in the coursework. An output can be a scoring of the student progress.
3. Job classification. In this example, the input can include user data (e.g., from an employer or agency) such as but not limited to a description of the job, the skills certification required, the culture of the workplace, and the amount of baseline experience preferred. The module can be implemented to generate a metric based on the input data for matching users to the potential opportunity. For example, the input can be in the form of a completed profile and/or xml sheet that is competed, e.g., by an employer or agency, or through an application programming interface (API) directly with the employer or agency's system. Example input data includes job location, skill set preferred, certification preferred, industry sector. Example output can be a rating of a job opportunity, a rating for a user that is undergoing the coursework, a match of the job to a user who has completed coursework on the system, or a classification of a particular company to the metric.
4. Employability score generator. In this example, the input can include user data. The output is a scoring for each user based on a set of parameters.
5. Job type/opportunity matching. In this example, a module can be used to compare the generated employability score to the metric derived for each job opportunity or job type by the system. The output can be an indicator of a degree of match or mismatch between the user and the job opportunity or job type, such as but not limited to a numerical scoring of degree matching or descriptive indicator (including phrases to indicate levels of matching).
6. Job deconstructor. In this example, a module is provided that develops the taxonomy for each different job opportunity or job type. The module deconstructs content for the job opportunity or job type, performs benchmarking of content against jobs taxonomy, and performs a knowledge-based skills assessment against job levels to determine skill sets that match a given job opportunity or job type. In an example, it is a Knowledge Skills Ability (KSA) assessment. The module can be implemented to deconstruct content associated with the job type or job opportunity and can be used to perform a GAP analysis of job skills that align with the content for the job opportunity or job type. The module also allows capture of greater amounts of data from publicly available databases, including the Department of Labor, to develop the taxonomy.

The example systems, methods, and computer-readable media according to the principles herein are accessible from many different types of web portals. A user can visit a web site that provides a user interface to the example systems, methods, and computer-readable media described herein.

Any of the output described herein can be delivered in various formats, for example according to a user preference. The output may be delivered as a Portable Document Format (PDF) document, as a web page (for example, based on a markup language file), or in an electronic book format (including an e-book or other electronic book accessible by an electronic reader). Non-limiting examples of applicable markup language files include a HTML file based on a variation of the markup language, including XHTML and HTML5, and a markup language embedded in or called from HTML including Cascade Style Sheet (CSS) and JavaScript. In an example, the output may be delivered as a link in an electronic transmission (such as email), and the user gains access to the body of the output by following the link.

In a non-limiting example implementation, the example systems, methods, and computer-readable media described herein can be implemented on a computing device, including a smartphone, a tablet, a slate, or other touch-based device or other hand-held device, a laptop, a notebook, or other portable computer-based device. In a non-limiting example implementation, the example systems, methods, and computer-readable media described herein can be implemented on a computer-based viewing device that may be part of a booth, a kiosk, a pedestal or other type of physical support.

In an example, a system or apparatus according to the principles described herein can be configured to provide a centralized, customized and personalized platform that allows an individual (including a student) to stack career pathways from as early as from a period of certification or credentialing to a later point in their education and/or vocational development, such as but not limited to a time of a 2 year degree (including Associates degree), or a 4 year degree (including a Bachelors degree), and beyond, In an example, a hybrid environment is provided where an administrator (such as but not limited to a college administrator and/or a career specialist) can interact with an individual (such as but not limited to a student) in real time. An example system and apparatus can be configured to facilitate tracking of the individual's data (with their consent).

In an example, using at least one processing unit or module of an example system or apparatus, an employability score can be computed for an individual. The employability score can be compared to deconstruction parameters for a real-time job, internship, and/or other opportunity within the individual's specified geographical region, industry and/or skill set.

In an example, a system or apparatus according to the principles described herein can be configured to provide a comprehensive system that allows for the simple integration of existing solutions into enterprise resource planning systems, course registration systems, degree planning systems, and/or other applicant tracking Systems.

In an example, a system or apparatus according to the principles described herein can be configured to display job recommendations to an individual user based on the analysis of the received data and/or the classification described herein.

In an example, a system or apparatus according to the principles described herein can be configured to a pathway map to an individual based on analysis of the received data and/or the classification described herein. The pathway map can include data indicative of the coursework recommendation, career pathway recommendation, and/or an employability score computed based on received data associated with the individual. The example system and or apparatus can be configured to store data indicative of the progress of the individual as they follow the pathway map.

In an example, a system or apparatus according to the principles described herein can be configured to provide continual and/or real-time updates to the pathway map generated for the individual based on the computation of the assessment vector associated with the individual, and/or the GAP analysis comparing the assessment vector to a database of job taxonomy vectors. Each job taxonomy vector can include data indicative of deconstruction parameters associated with a specified job.

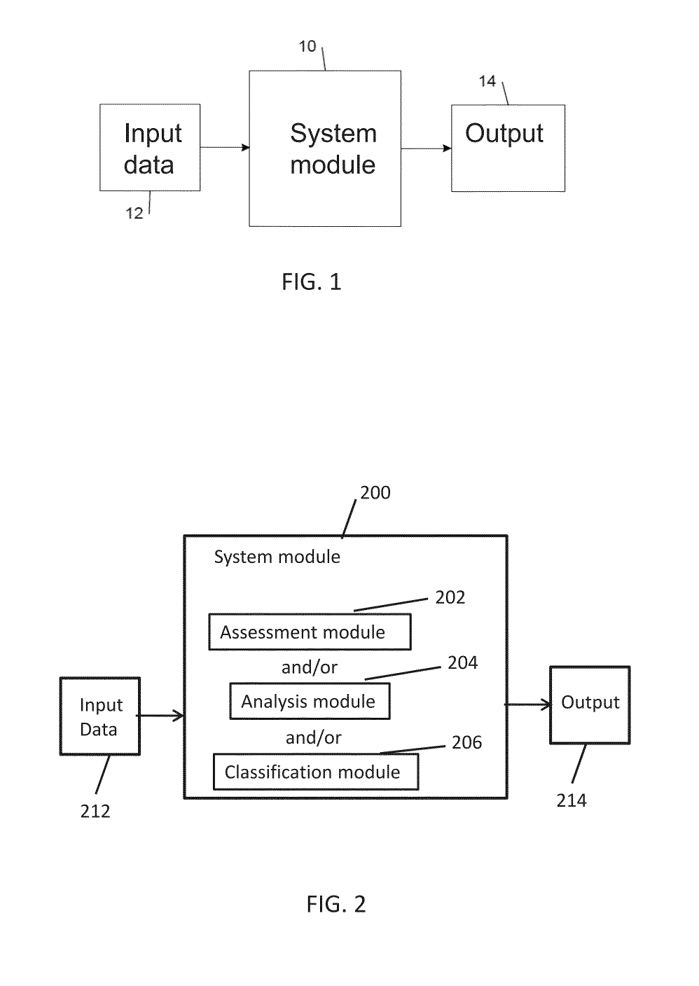

FIG. 1 shows an example of a system module 10 that can be used to perform any of the procedures according to the principles described herein on input data 12 and to provide output 14, For example, an example system module 10 can be configured to perform at least one of: the skills assessment, monitoring and evaluating user progress through coursework, job classification, employability score generation, job type/opportunity matching, and the job deconstruction. For each different configuration of the example system module 10, the input data 12 and output 14 can be as described above for the given configuration of the example system module 10. The system module 10 can be implemented as a fully automated process on receipt of the input data 12.

FIG. 2 shows a block diagram for an example implementation of a system and apparatus that includes a system module 200 to be used for generating an adaptive career pathway for an individual. As shown in FIG. 2, system module 200 includes one or more of an assessment module 202, an analysis module 204, and a classification module 206. The assessment module 202 can be implemented to compute an assessment vector associated with the individual based on received input data 212. The received input data 212 can data indicative of two or more of an educational level, a skill level, a personality metric, a residence location, a score in an educational course, a score in a vocational course, a job location, and a skill set selected by the individual. The analysis module 204 can be implemented to apply a GAP analysis to compare the assessment vector to a database of job taxonomy vectors, wherein each job taxonomy vector comprises data indicative of deconstruction parameters associated with a specified job. The classification module 206 can be implemented to classify the individual, based on the GAP analysis, according to at least one of a coursework recommendation, a career pathway recommendation, and an employability score. The example system and apparatus can include a communication interface to transmit an output 214, and/or can control the memory to store the output 214.

In an example, the deconstruction parameters can be generated based on assessment vector from a plurality of known individuals, wherein the plurality of known individuals include a first set of individuals that retained the specified job for longer than a probationary period.

In an example, the plurality of known individuals can include a second set of individuals that retained the specified job for longer than a probationary period.

In an example, the classification module 206 can be implemented to classify the individual according to the coursework recommendation by identifying educational courses and/or vocational courses, recommending a sequence of taking the educational courses and/or the vocational courses, and providing an expected score for at least of the educational courses and/or the vocational courses.

The classification module 206 can be used to determine a deviation of the individual's actual score for the at least of the educational courses and/or the vocational courses from the expected score, where the deviation indicates poor performance of the individual.

The example system and apparatus can further include a communication module to: (i) display data indicative of the result of the classification to at least one of the individual and a system administrator, and/or (ii) facilitates real-time communication between the individual and the system administrator, and/or (iii) display data indicative of the deviation to at least one of the individual and a system administrator.

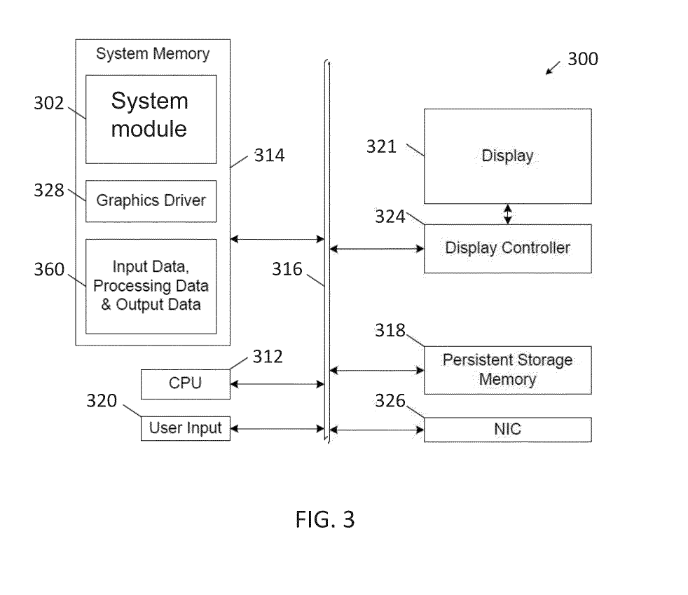

FIG. 3 shows an example of a computer system 300 that can implement any of the examples of the system modules 302 that are described herein. The computing system can be any computing device, including any of the computing devices described herein. In an example, the computer system 300 is a portable device or a computer-based viewing device described herein. Although each element (including each module) is illustrated as a single component, it should be appreciated that each illustrated component can represent multiple similar components, including multiple components distributed across a cluster of computer systems. The computer system 300 includes a processing unit 312 (CPU), and a system memory 314. Processing unit 312 is coupled to the various components of the computer system 300. The processing unit 312 typically includes one or more processors or coprocessors, each of which may be in the form of any one of various commercially available processors. The system memory 314 typically includes a read only memory (ROM) that stores a basic input/output system (BIOS) that contains start-up routines for the computer system 300 and a random access memory (RAM). System memory 314 may be of any memory hierarchy or complexity in the art. The computer system 300 may include a system bus 316, which may be a memory bus, a peripheral bus or a local bus, and may be compatible with any of a variety of bus protocols, including PCI, VESA, Microchannel, ISA, and EISA. The illustration shows a single system bus 316, however computer system 300 may include multiple busses. The computer system 300 may include a persistent storage memory 318 (e.g., a hard drive, a floppy drive, a CD ROM drive, magnetic tape drives, flash memory devices, and digital video disks) that is connected to the system bus 316 and contains one or more computer-readable media disks that provide non-volatile or persistent storage for data, data structures and other computer-executable instructions.

Interactions may be made with the computer system 300 (e.g., by entering commands or data) using one or more input devices 320 (e.g., a keyboard, a computer mouse, a microphone, joystick, or a touch pad). Information may be presented through a user interface that is displayed to a user on the display 321 (implemented by, e.g., a display monitor or display screen), which is controlled by a display controller 324. The display controller may be implemented by, e.g., a video graphics card. The display 321 can be a display screen of a portable viewing device or computer-based viewing device. The computer system 300 may includes peripheral output devices, such as speakers and a printer. In an example where computer system 300 is, e.g., a desktop computer, a laptop computer, may include a network interface card (MC) 326 that facilitates connection with one or more remote computers.

As shown in FIG. 3, the system memory 314 can store one or more components of the system module 302, a graphics driver 328, and processing information 360 that includes input data, processing data, and output data. In some examples, the system module 302 interfaces with the graphics driver 328 to present a user interface on the display 321 for managing and controlling the operation of the system module 302.

System module 302 may include one or more discrete data processing components, each of which may be in the form of any one of various commercially available data processing chips, In some implementations, the system module 302 is embedded in the hardware of any one of a wide variety of digital and analog computer devices, including desktop, workstation, server computers, portable devices, and computer-based viewing devices. In some examples, the system module 302 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

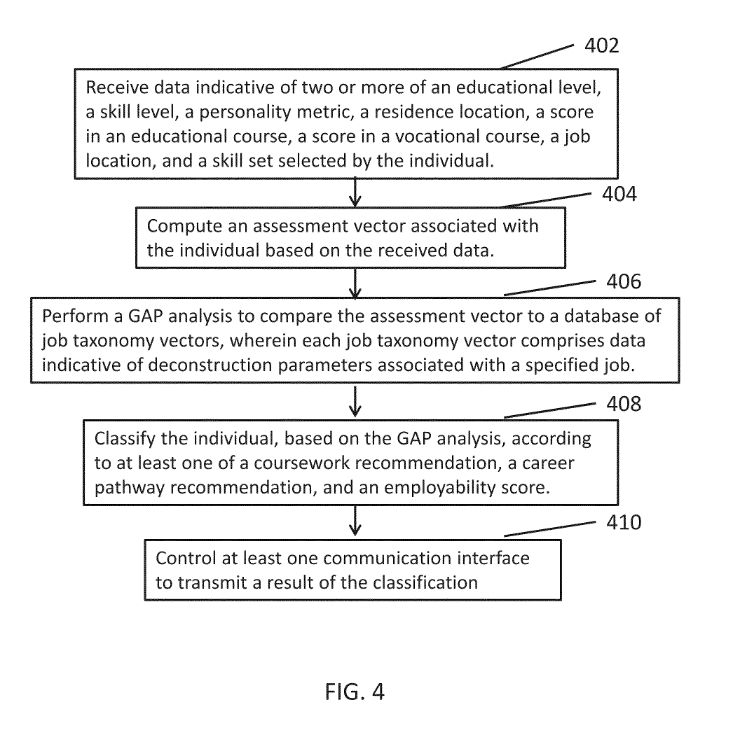

FIG. 4 shows a flowchart of an example system, method and apparatus for generating an adaptive career pathway for an individual. In 402, data is received that is indicative of two or more of an educational level, a skill level, a personality metric, a residence location, a score in an educational course, a score in a vocational course, a job location, and a skill set selected by the individual. In 404, an assessment vector associated with the individual is computed based on the received data. In 406, a GAP analysis is performed to compare the assessment vector to a database of job taxonomy vectors, wherein each job taxonomy vector comprises data indicative of deconstruction parameters associated with a specified job. In 408, the individual is classified, based on the GAP analysis, according to at least one of a coursework recommendation, a career pathway recommendation, and an employability score. In 410, at least one communication interface can be controlled to transmit a result of the classification. In another example, the memory can be used to store the result of the classification.

An example apparatus to perform 402 to 410 can include at least one communication interface, at least one memory to store processor-executable instructions, and at least one processing unit, communicatively coupled to the at least one communication interface and the at least one memory. Upon execution of the processor-executable instructions, the at least one processing unit of the example apparatus can be implemented to perform 402 to 410.

In an example, the at least one communication interface transmits the result of the classification to at least one of the individual and a system administrator.

In an example, the at least one communication interface facilitates real-time communication between the individual and the system administrator.

In any of the examples herein, the deconstruction parameters can be generated based on assessment vector from a plurality of known individuals, where the plurality of known individuals include a first set of individuals that retained the specified job for longer than a probationary period. The plurality of known individuals can include a second set of individuals that retained the specified job for longer than a probationary period.

In an example, the at least one processing unit can be used to classify the individual according to the coursework recommendation by identifying educational courses and/or vocational courses, recommending a sequence of taking the educational courses and/or the vocational courses, and providing an expected score for at least of the educational courses and/or the vocational courses.

In an example, the at least one processing unit can be used to determine a deviation of the individual's actual score for the at least of the educational courses and/or the vocational courses from the expected score, where the deviation indicates poor performance of the individual. The at least one processing unit may be used to provide an alert of the deviation to at least one of the individual and a system administrator. The expected score can he a grade point average.

In an example, the at least one processing unit can be configured to receive pre-enrollment data, where the pre-enrollment data is data associated with the individual prior to enrollment in an educational course and/or an vocational course.

In an example, the at least one processing unit can be configured to receive data indicative of a job performance of the individual based on the career pathway recommendation. The at least one processing unit generates deconstruction parameters associated with the specified job based on the data indicative of a job performance of the individual.

In an example implementation, a graphical user interface (GUI) is provided for facilitating generation of an adaptive career pathway for an individual. The example GUI can includes two or more graphical interface pages arranged in a hierarchical format or a navigable format. The two or more graphical interface pages can include: (A) at least one graphical interface page to receive input data indicative of two or more of an educational level, a skill level, a personality metric, a residence location, a score in an educational course, a score in a vocational course, a job location, and a skill set selected by the individual; and (B) at least one graphical interface page to display data indicative of a classification of the individual according to at least one of a coursework recommendation, a career pathway recommendation, and an employability score. As described herein, the classification can be performed based on a GAP analysis comparing: (i) an assessment vector associated with the individual, computed based on the received data, and (ii) a database of job taxonomy vectors, each job taxonomy vector comprising data indicative of deconstruction parameters associated with a specified job.

In an example implementation, the two or more graphical interface pages can include at least one graphical interface page to display the result of the classification to at least one of the individual and a system administrator.

In an example, the at least one graphical interface page can be configured to display the result of the classification facilitates real-time communication between the individual and the system administrator.

In an example implementation, the two or more graphical interface pages can include at least one graphical interface page to display to at least one of the individual and a system administrator, at least one of: a recommended educational course, a recommended vocational course, a recommended sequence of taking an educational course and/or a vocational course, and an expected score for at least of an educational course and/or a vocational course.

In an example implementation, the two or more graphical interface pages can include at least one graphical interface page to display to at least one of the individual and a system administrator data indicative of a deviation of the individual's actual score for at least of the educational course and the vocational course from the expected score, where the deviation indicates poor performance of the individual.

### NON-LIMITING EXAMPLE IMPLEMENTATIONS

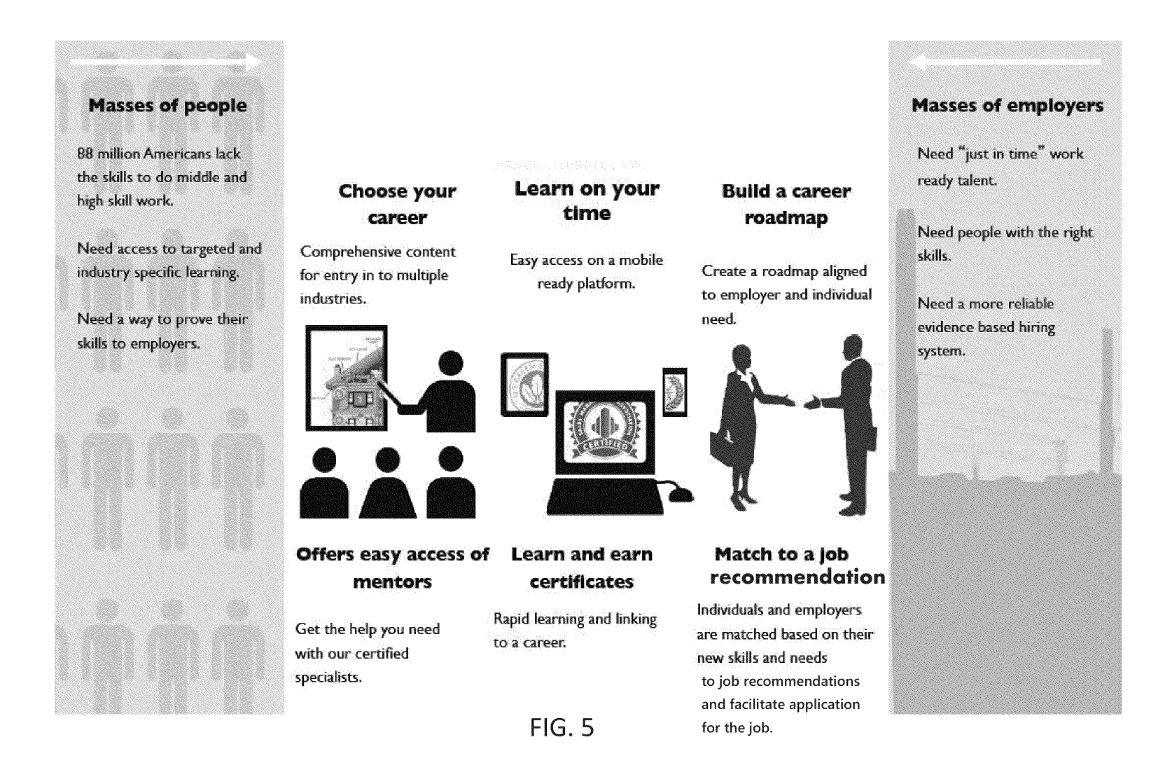

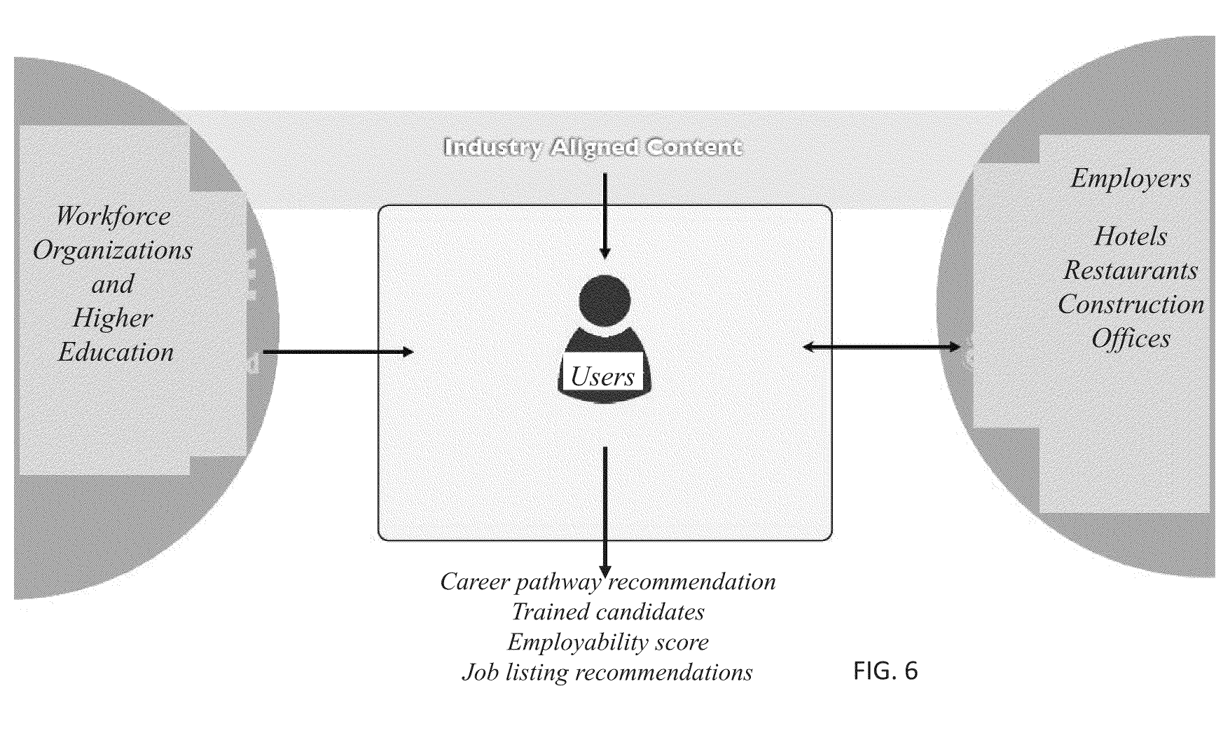

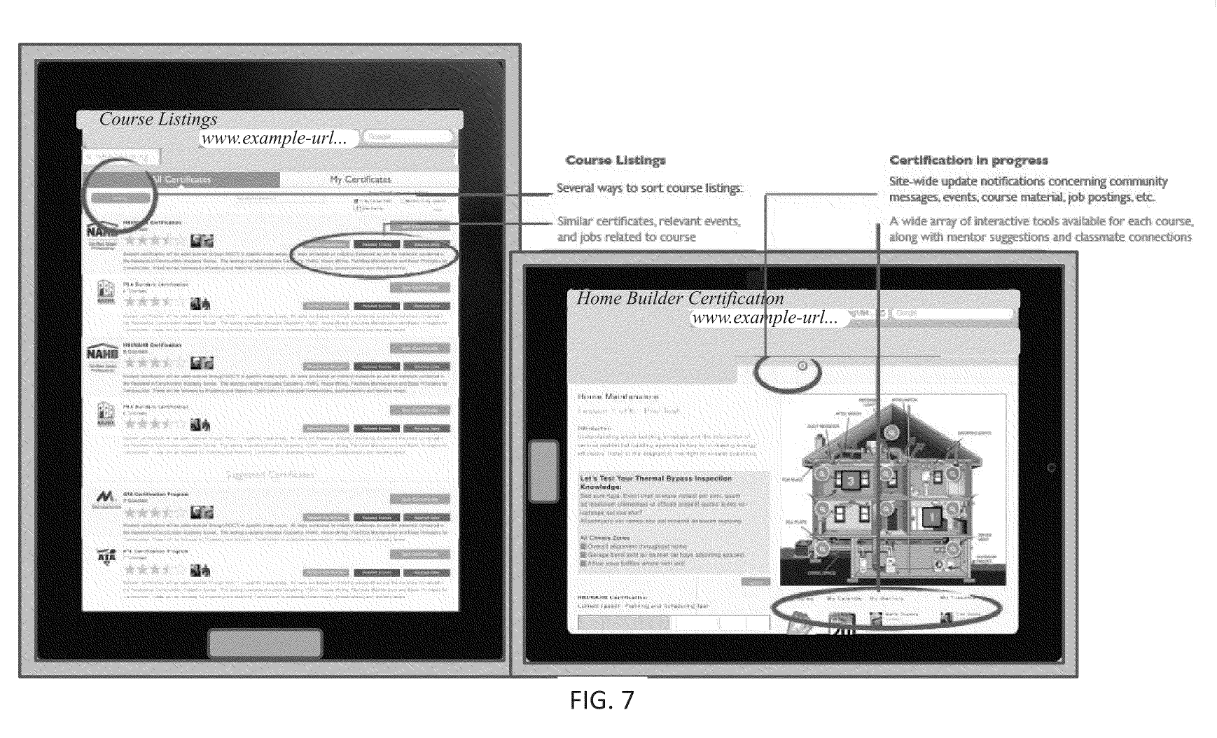

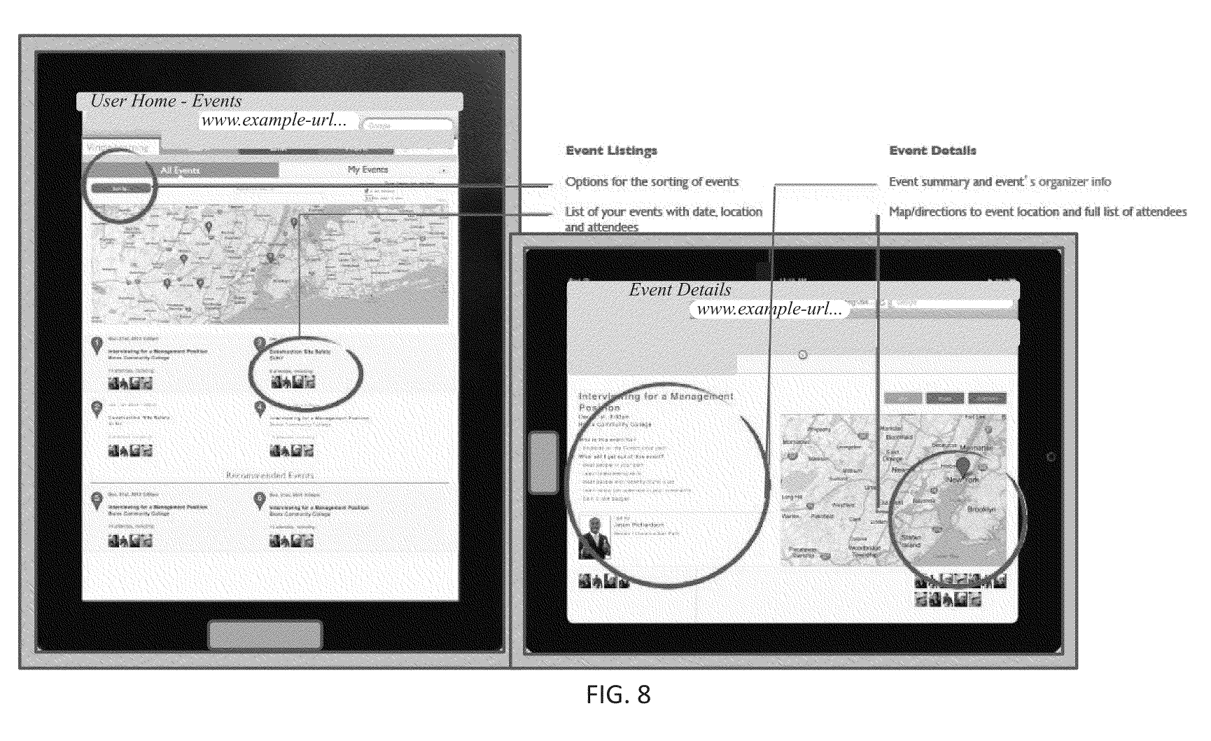

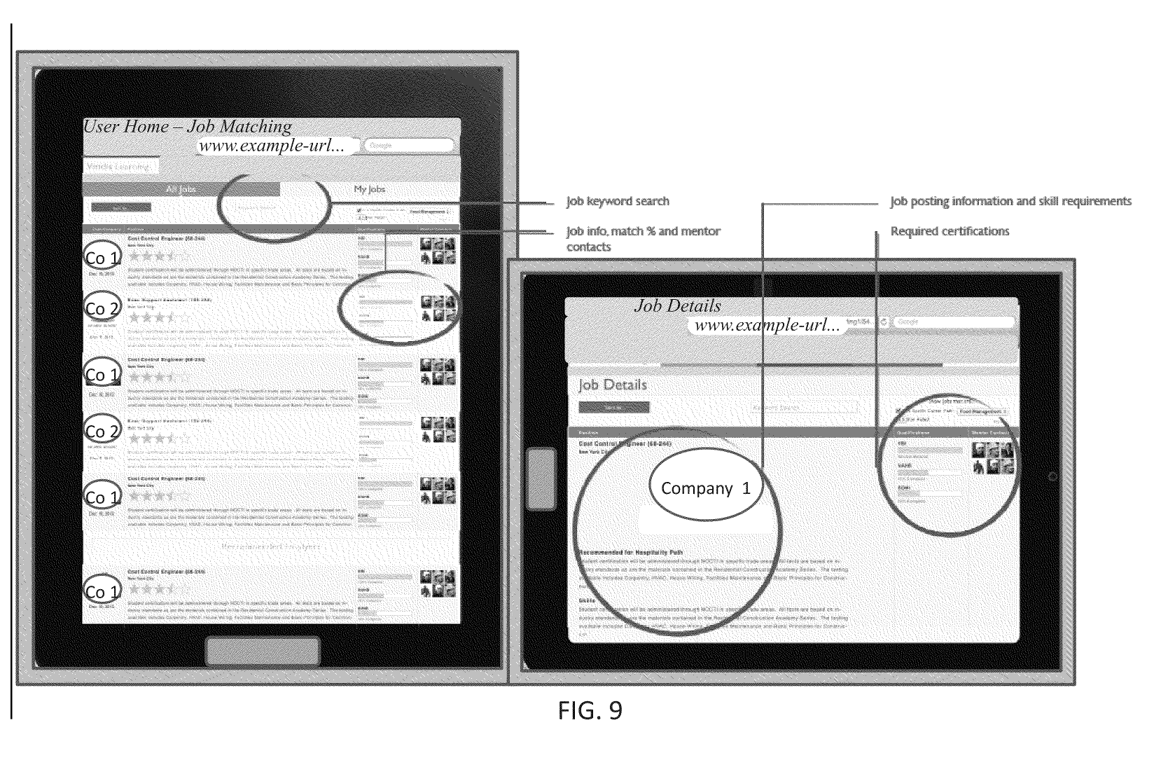

FIGS. 5-6 show a non-limiting example implementation according to the principles described herein. FIGS. 5 and 6 show flow-charts of different example implementations, showing data input, the execution of the example analysis and classification described herein (e.g., using a processor and/or a module), and the output results. FIGS. 7-9 show examples of GUIs (and other displays) of the user interface on implementation of the coursework, building of networks among user, and job matching for the user as a job candidate. FIG. 7 shows a GUI for learning a trade and earn a certification. FIG. 8 shows a GUI that an individual can use to link to other users and build a professional network. FIG. 9 shows an example GUI displaying an example candidate job matching.

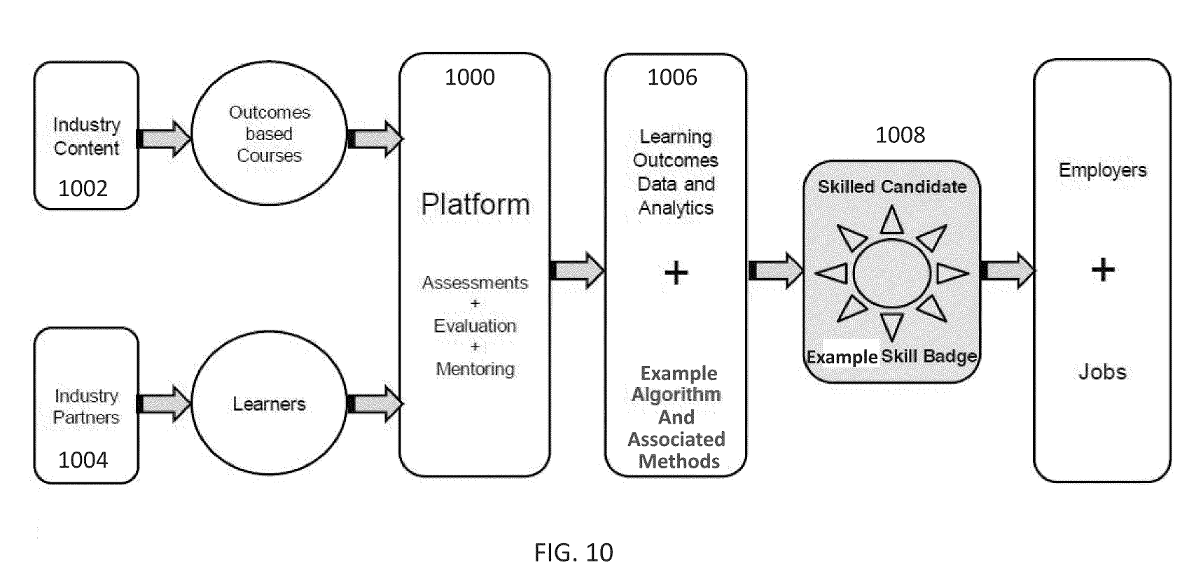

FIGS. 10-14 show block diagrams of an example platform, and example input and output at various stages of the implementation of the system.

FIG. 10 shows a block diagram of an example platform 1000 according to the principles herein, where the input includes industry content 1002 and data indicative of job preferences and requirements of industry partners 1004. The platform provides for computing a data-driven and evidence-based employability score. Using the trade association content received based on the data from the industry content 1002 and industry partners 1004, the platform 1000 can perform the assessment and evaluation of an individual candidate. In an example, the candidate can be seeking placement at the middle skill job level. The example platform 1000 can provide analysis results to a module 1006 to perform learning-based outcomes data and analytics. The individual can benefit from the career pathway by being trained as a skilled candidate 1008 for a specific type of job.

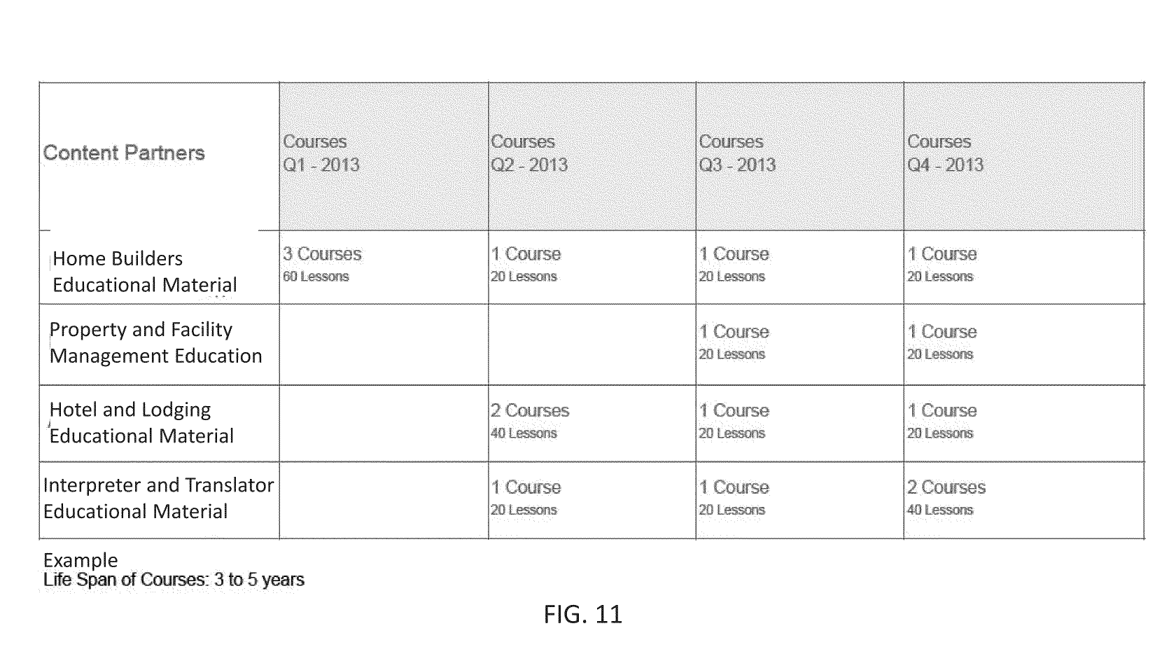

FIG. 11 shows and example output of a system or apparatus herein that indicates coursework (including educational and/or vocational courses) for an individual candidate based on the career pathway, as well as an indication of a sequence for following the coursework. In an example implementation, the coursework can be released according to a course content release cycle mapped onto the career pathway for the individual candidate. The example of FIG. 11 shows example coursework content according to industry sector.

In another example, the coursework can be based on the education services provided by an education services company (such as but not limited to educational materials by Pearson PLC (London, UK) and Pearson Inc., New York, N.Y.).

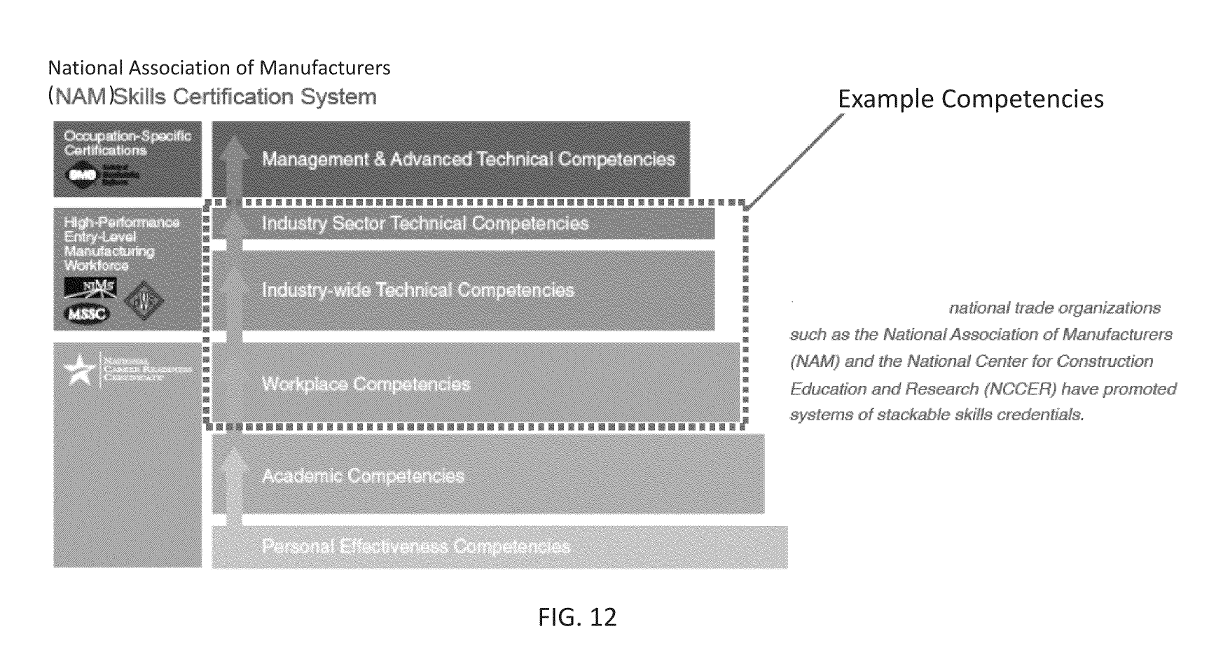

FIG. 12 shows an example of industry and workplace competencies that an individual candidate can be trained in to develop using the coursework and other features of the example systems, methods and computer-readable media according to the principles described herein.

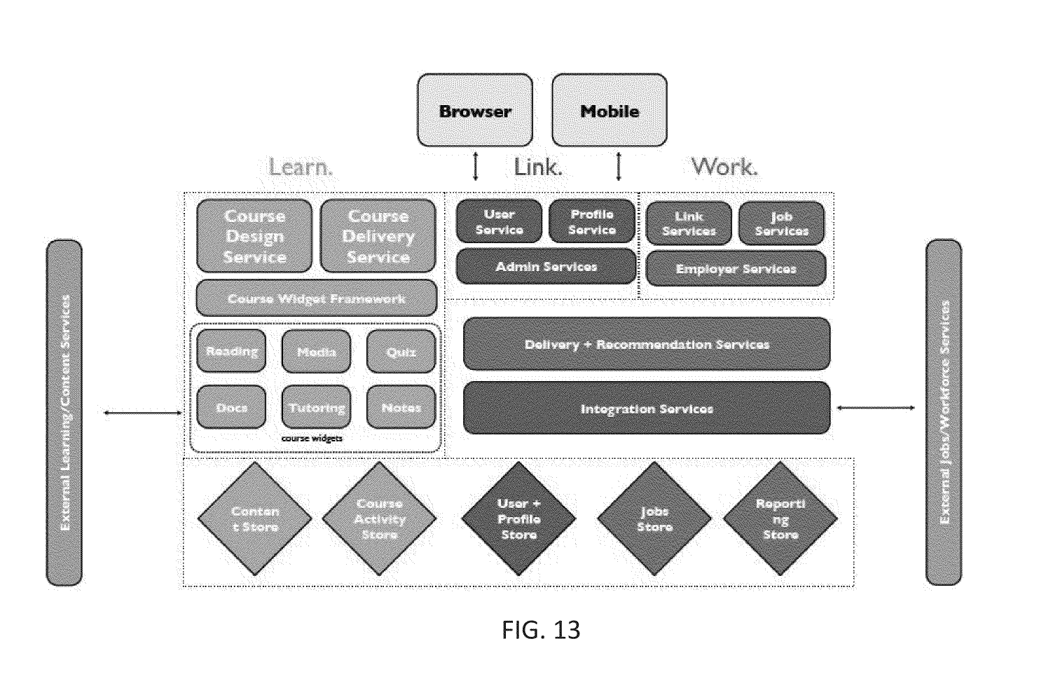

FIG. 13 shows an example of communication links that can be established between the example systems, methods and computer-readable media according to the principles described herein and one or more computing devices (including any computing device described herein).

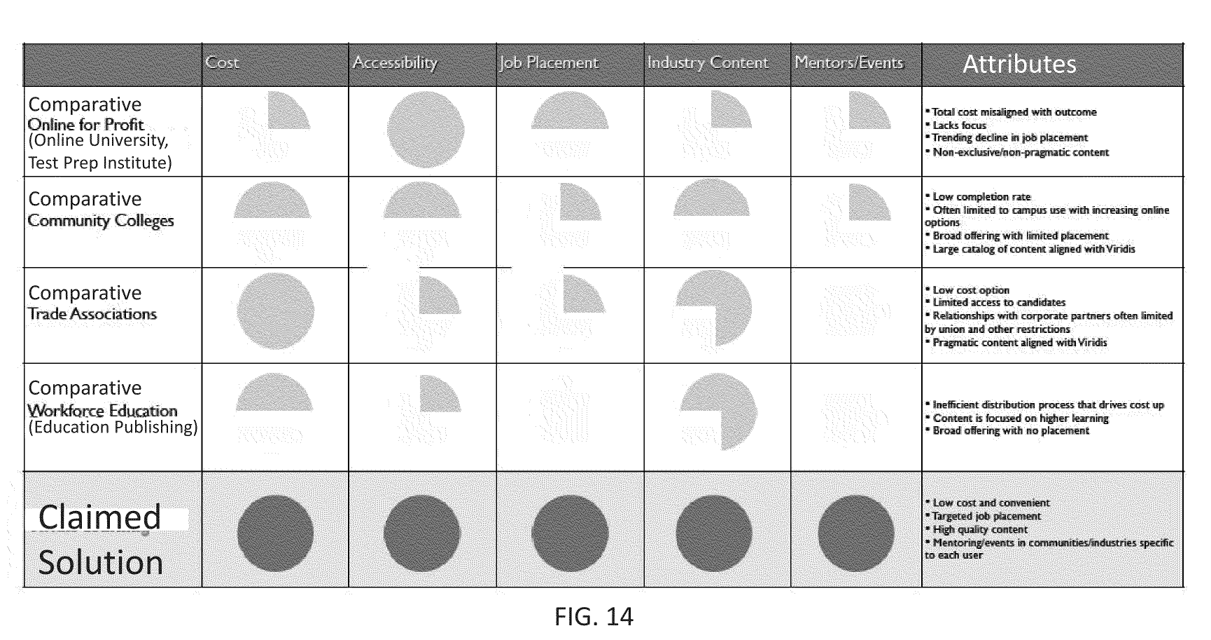

FIG. 14 shows a comparison of the results that can be derived using the example systems, methods and computer-readable media according to the principles described herein (the claimed solutions contained in the last row of the table), as compared to other existing systems (top four comparative rows).

In an example, the system and apparatus can be configured to provide a comprehensive program of customer relationship management (CRM). In this example, the system and apparatus can be configured to display user interfaces that facilitate administrative staff access to the output results for management of the career pathway, and/or using user interfaces that facilitate student access to the output results for the student to manage his/her progress through the course recommendations or career pathway.

In an example, the system and apparatus can be configured to provide a content management system (CSM). In this example, the system and apparatus can be configured to display user interfaces that facilitate course data analysis and management, and/or participant tracking.

In an example, the system and apparatus can be configured to provide a universal set of codes that an individual (e.g., a student) and a partner (e.g., a system administrator and/or a potential employer) can use to communicate with each other using an example system and apparatus herein.

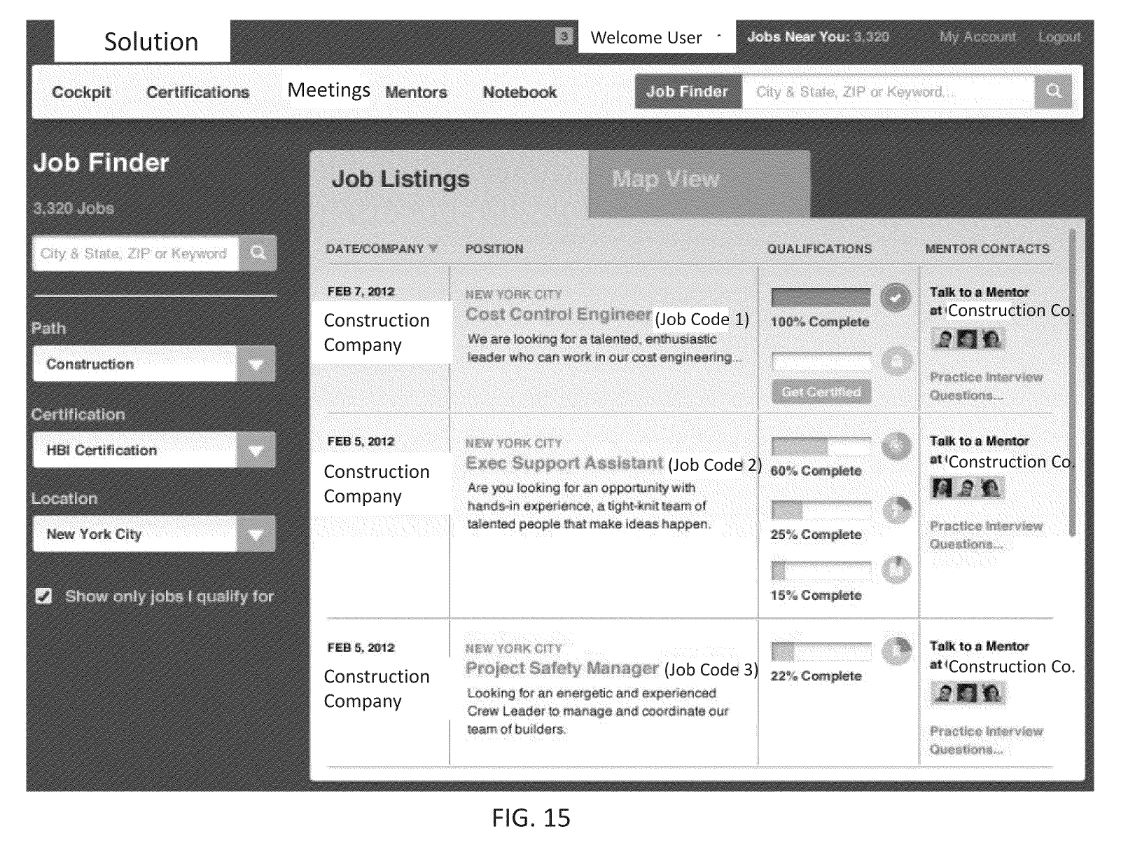

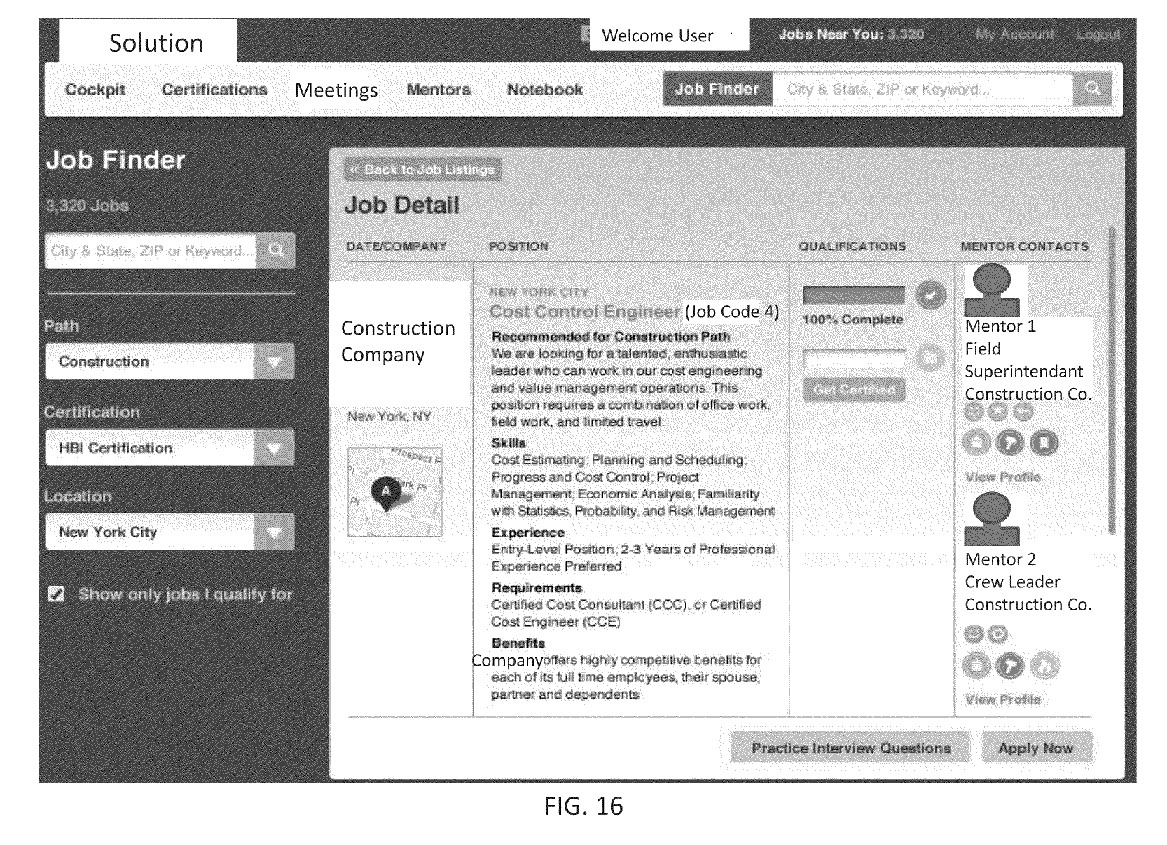

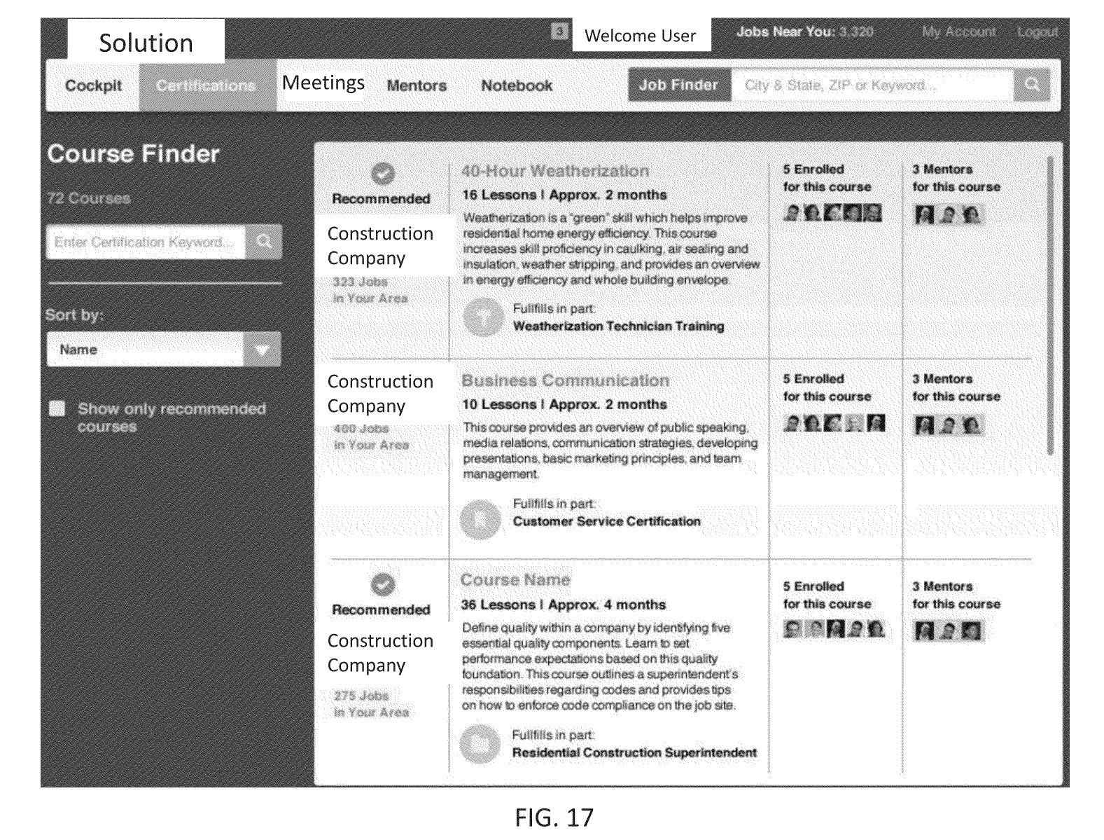

FIGS. 15-17 show non-limiting example displays of the user interface (including GUIs) for the coursework tool and the job matching tool of an example platform. In an example, a user interface is also provided that presents recommended jobs to an individual based on an analysis of the received data (e.g., data indicative of two or more of an educational level, a skill level, a personality metric, a residence location, a score in an educational course, a score in a vocational course, a job location, and a skill set selected by the individual). In an example, a user interface is also provided that presents recommended jobs to an individual based on the classification from the GAP analysis.

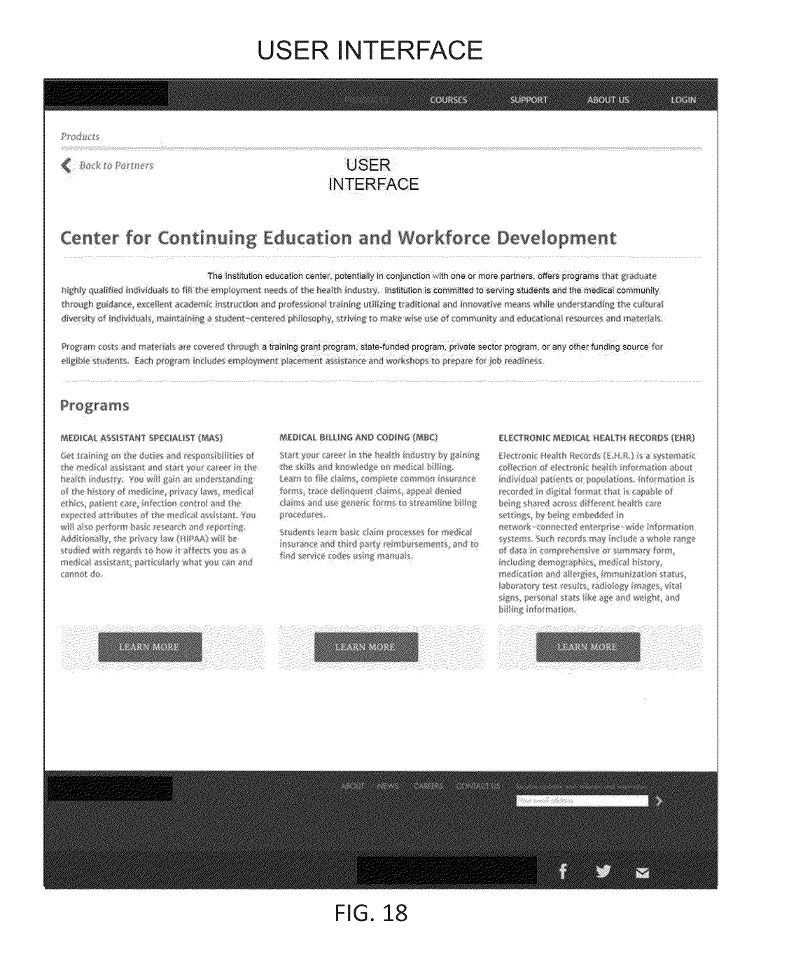

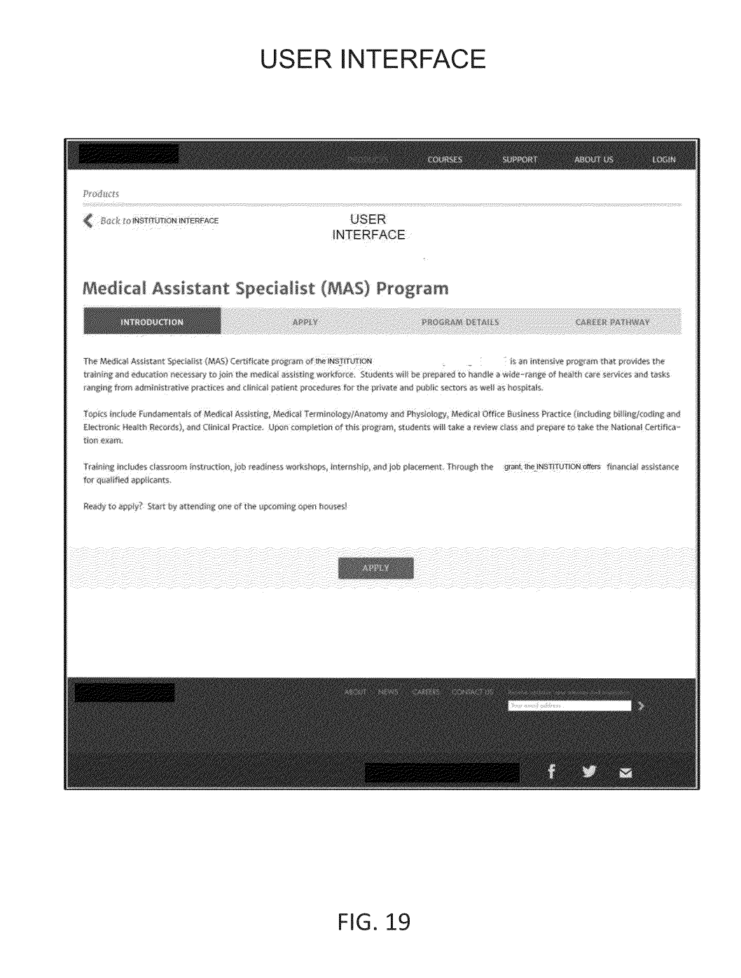

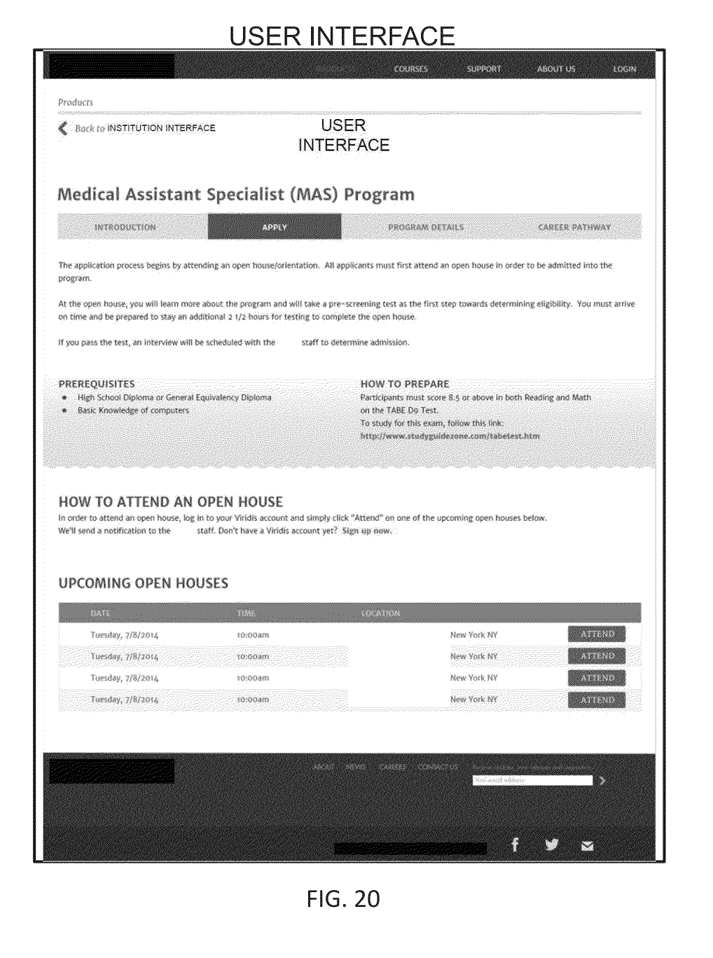

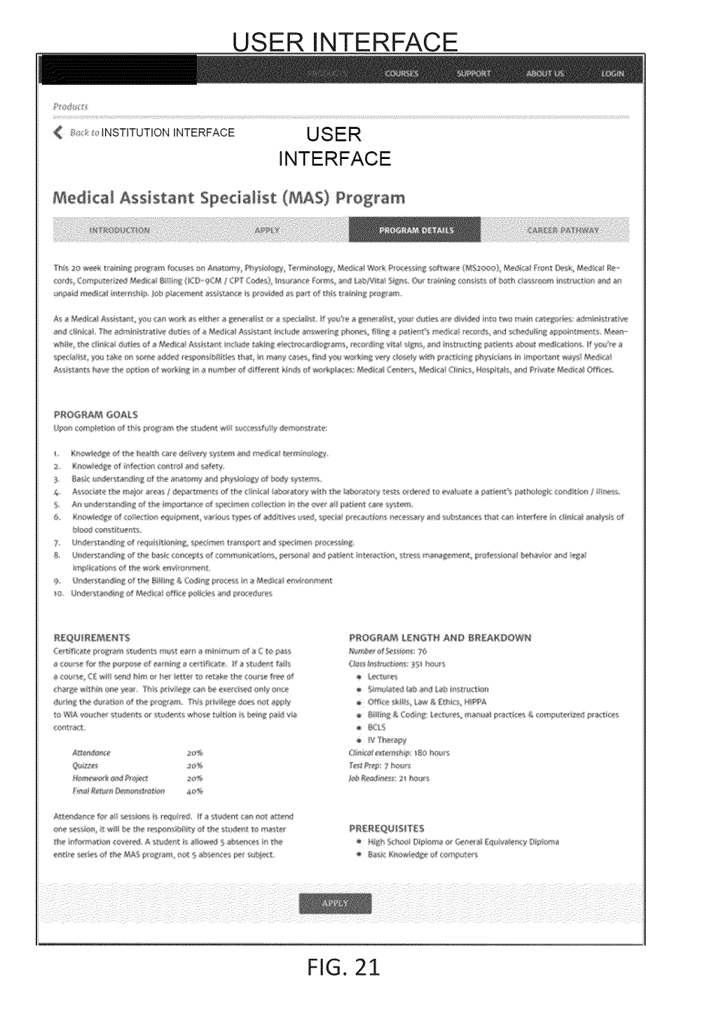

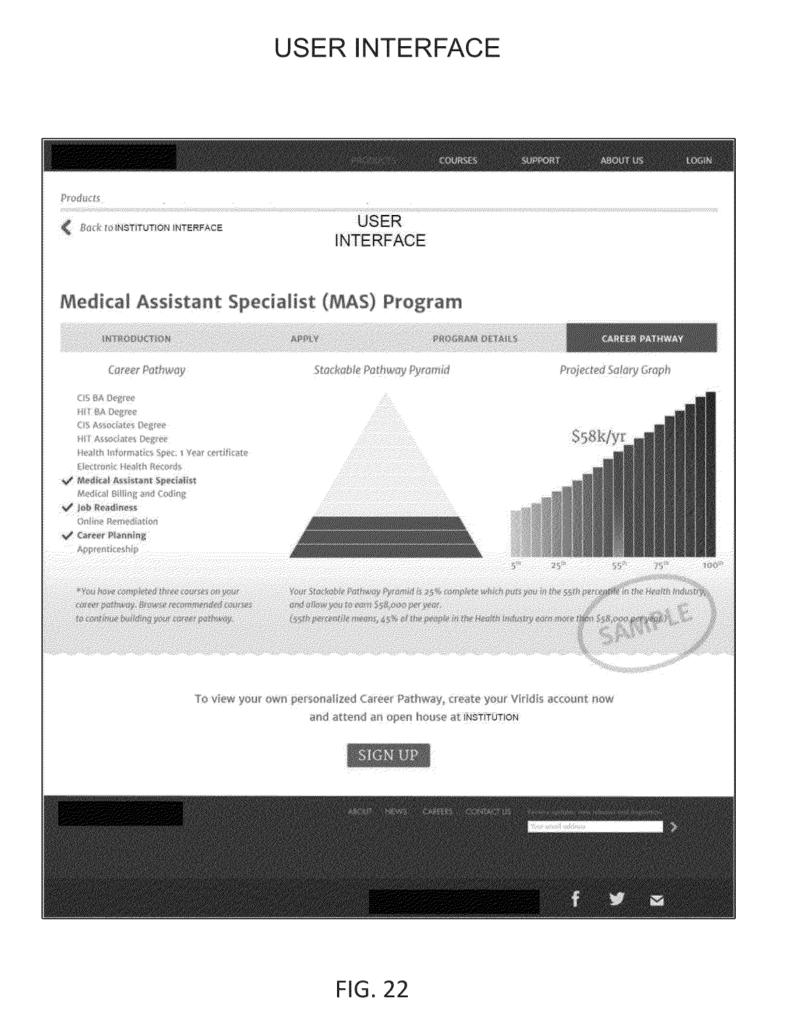

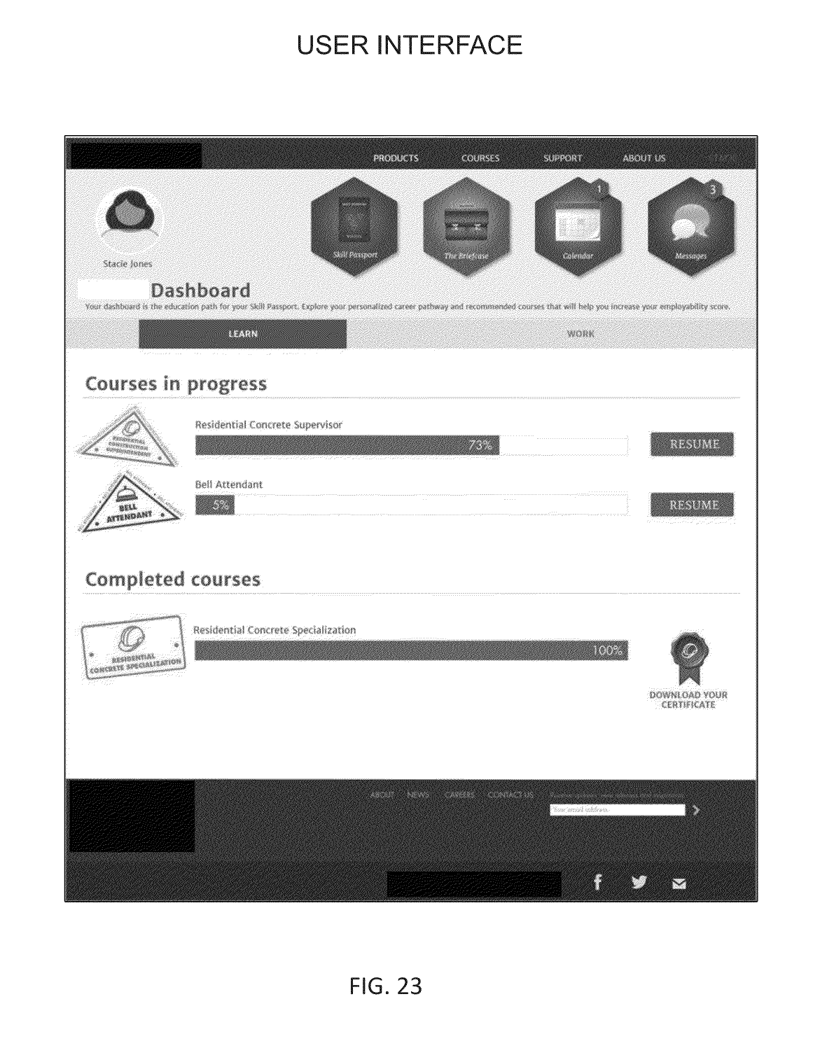

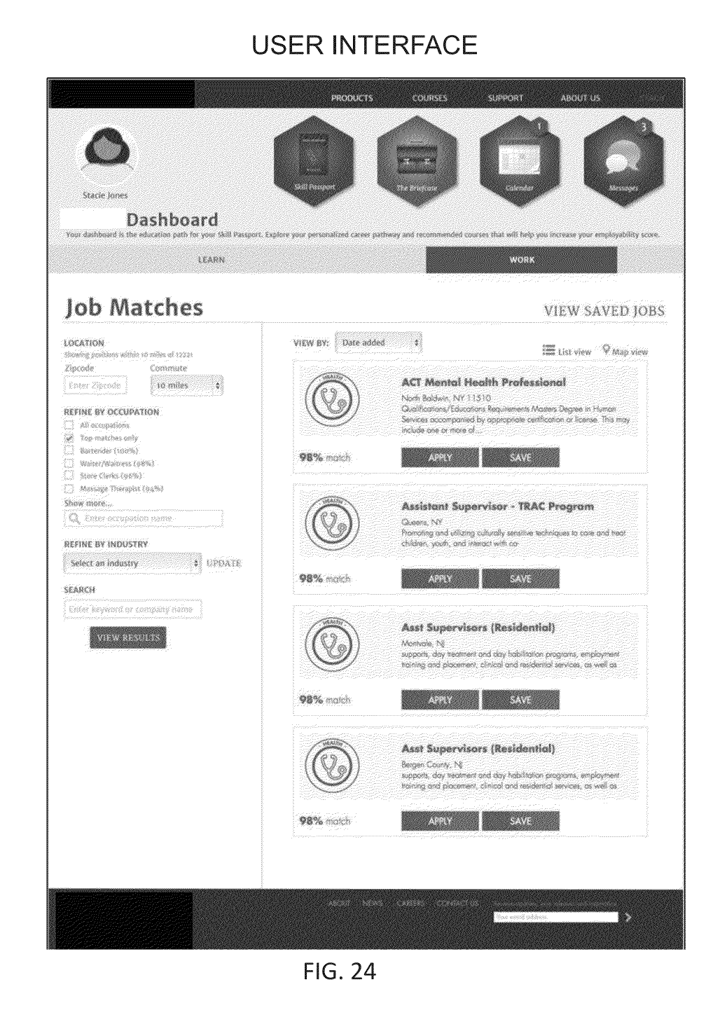

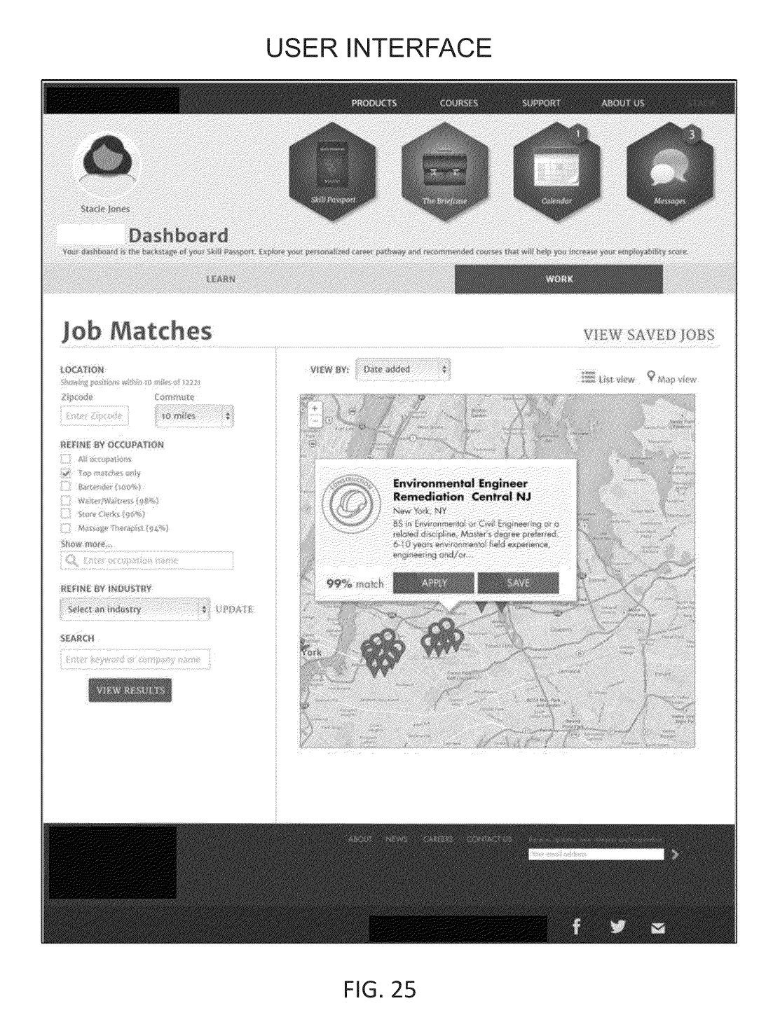

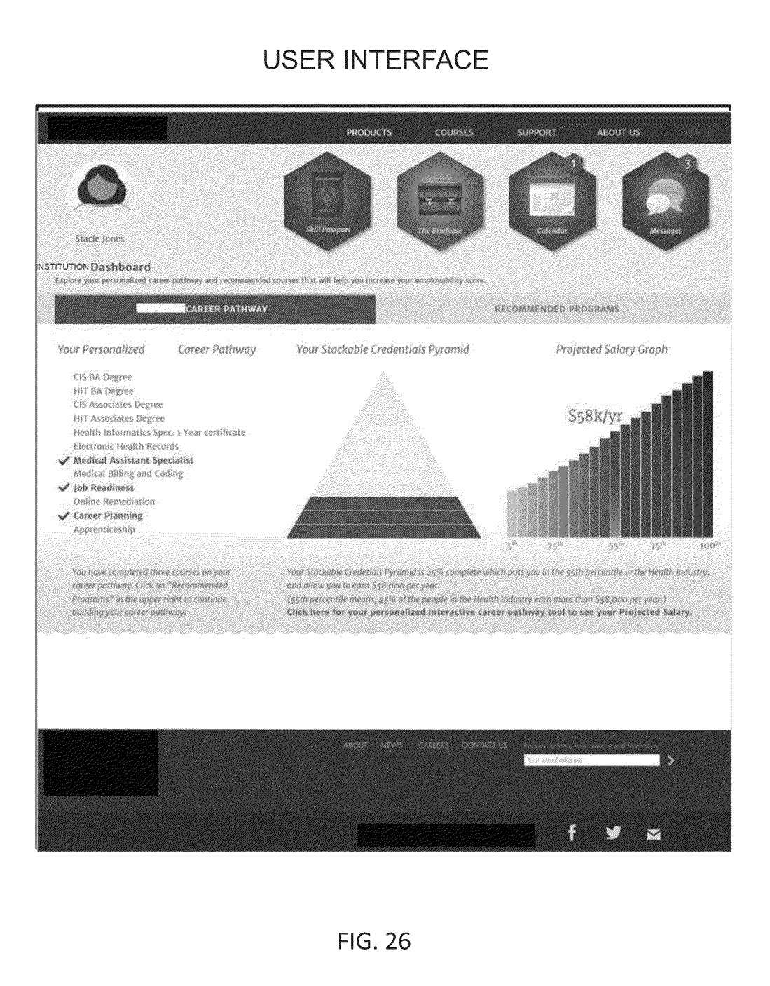

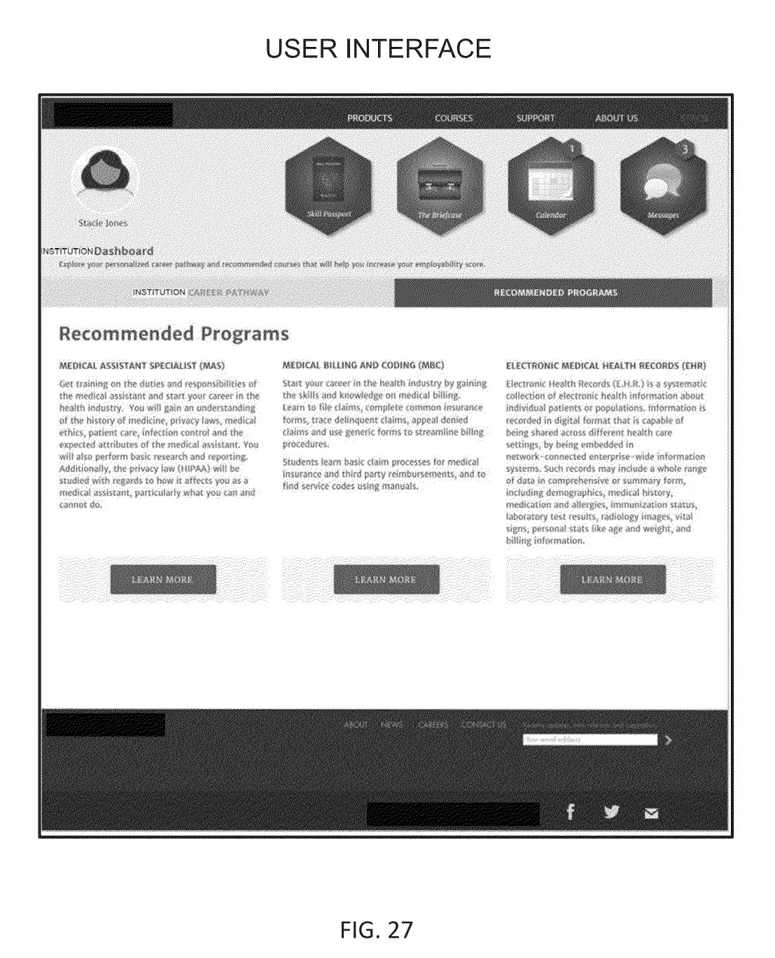

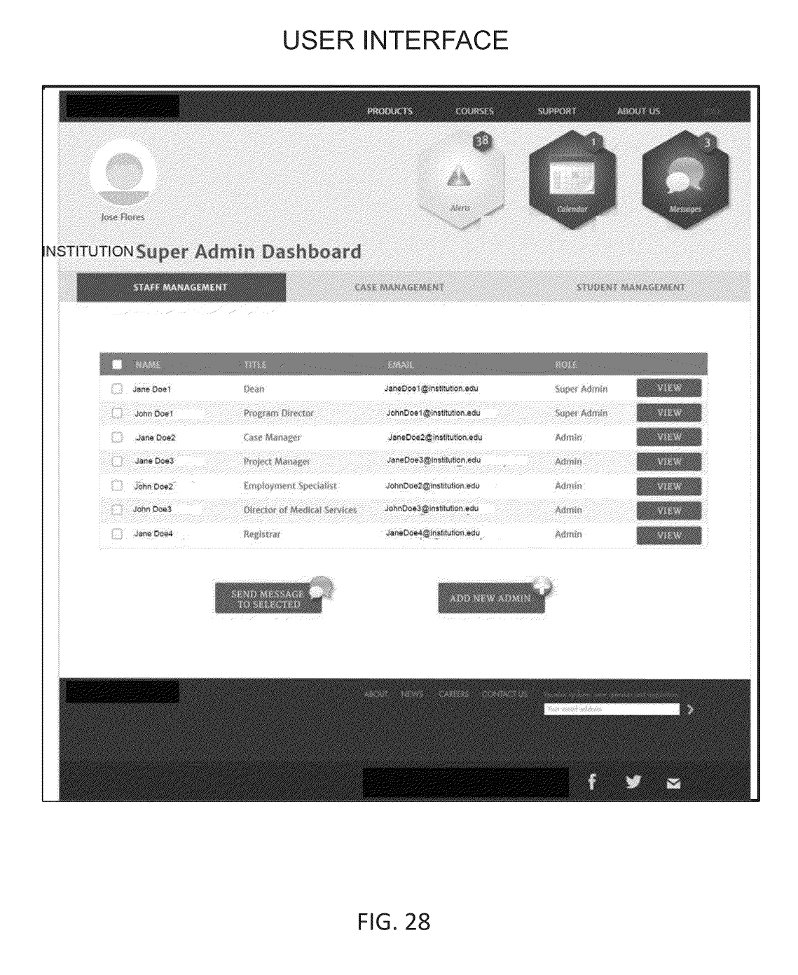

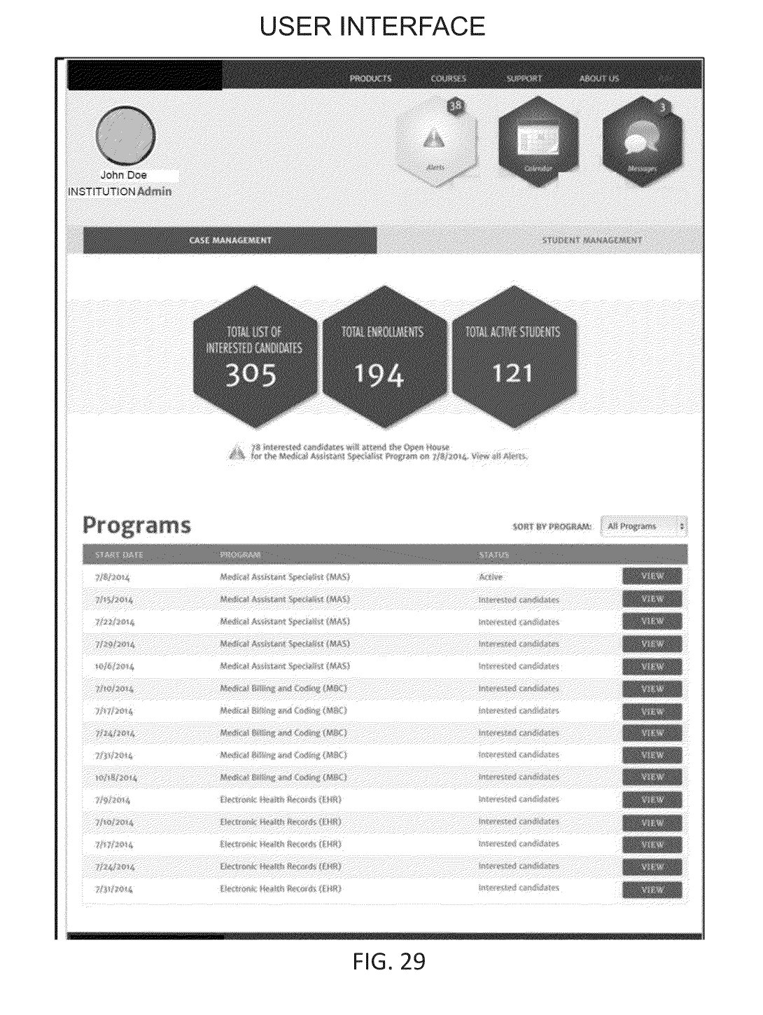

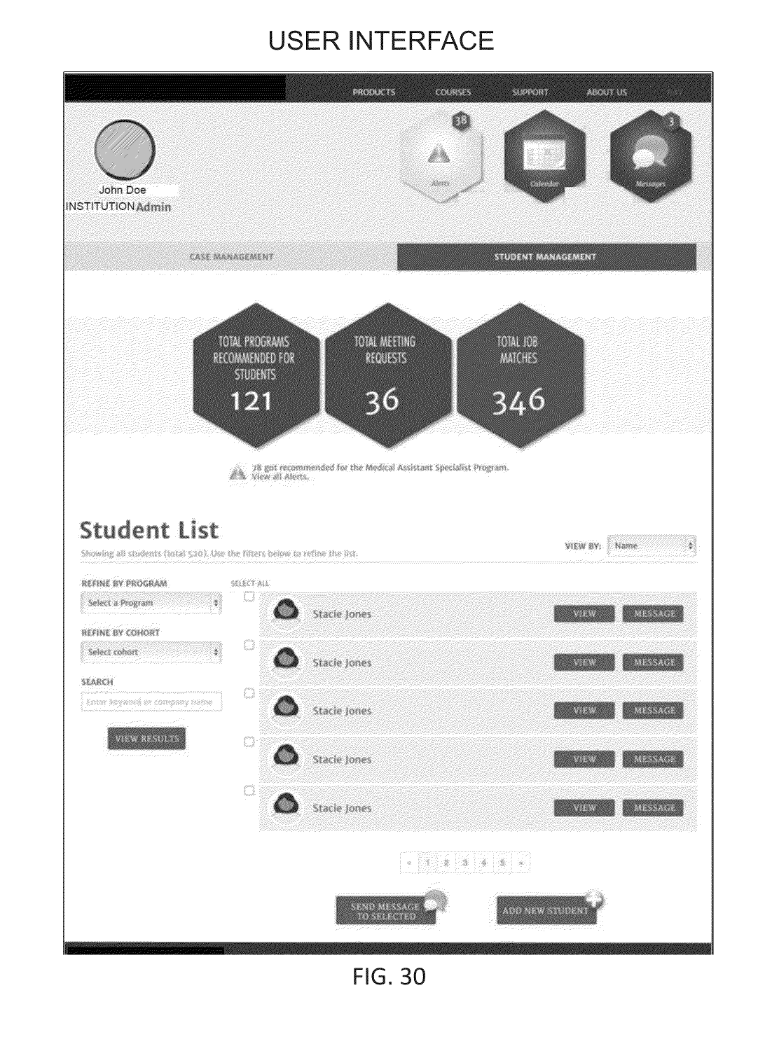

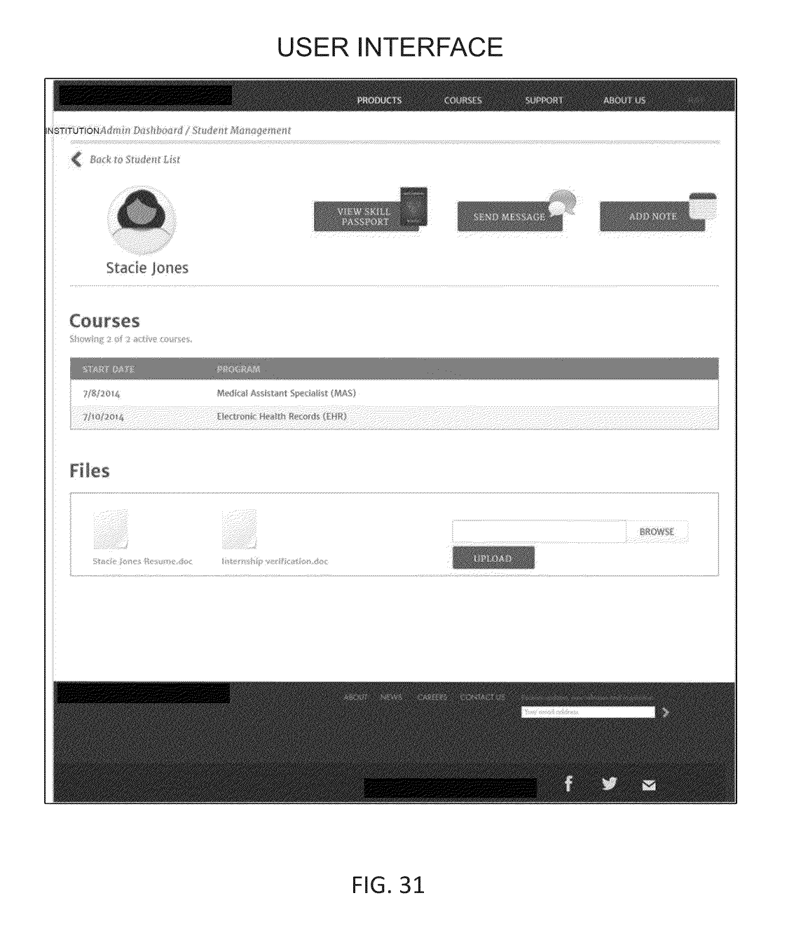

FIGS. 18-31 show non-limiting example displays of example user interfaces (including GUIs) of example implementations of an apparatus and system, where candidate user input data can be entered, and output results can be displayed. For example, the output results can be displayed to the individual who is following the career path map, or to another person or entity (with the consent of the individual). Any example systems and apparatus described herein can be sued to implement a coursework recommendation tool, a career pathway recommendation tool (including a job matching tool), and an employability score generator, of the example platform.

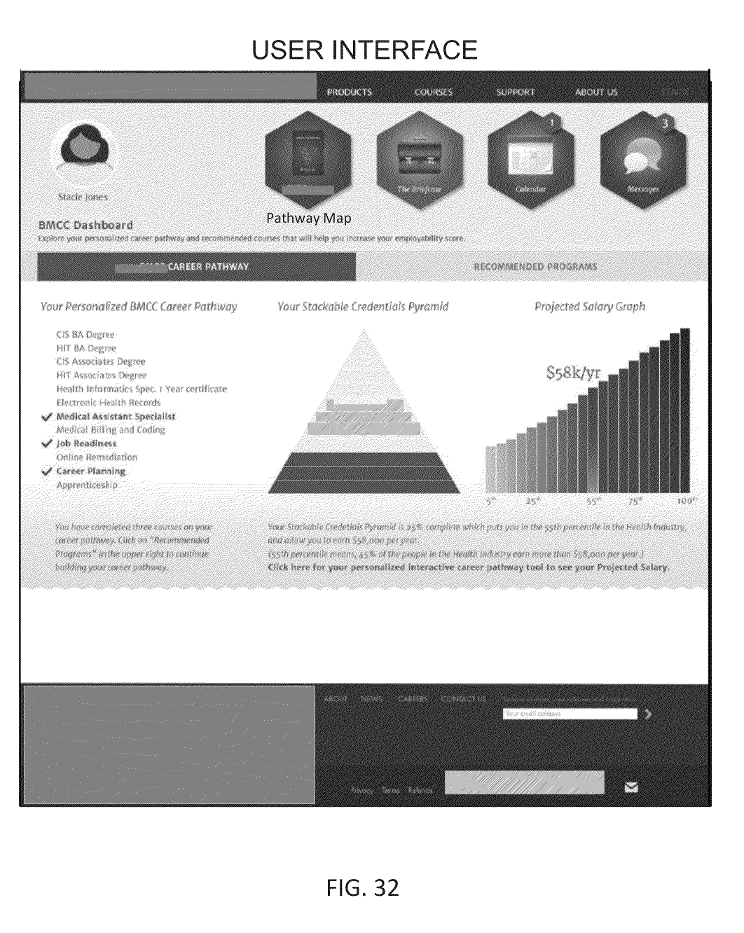

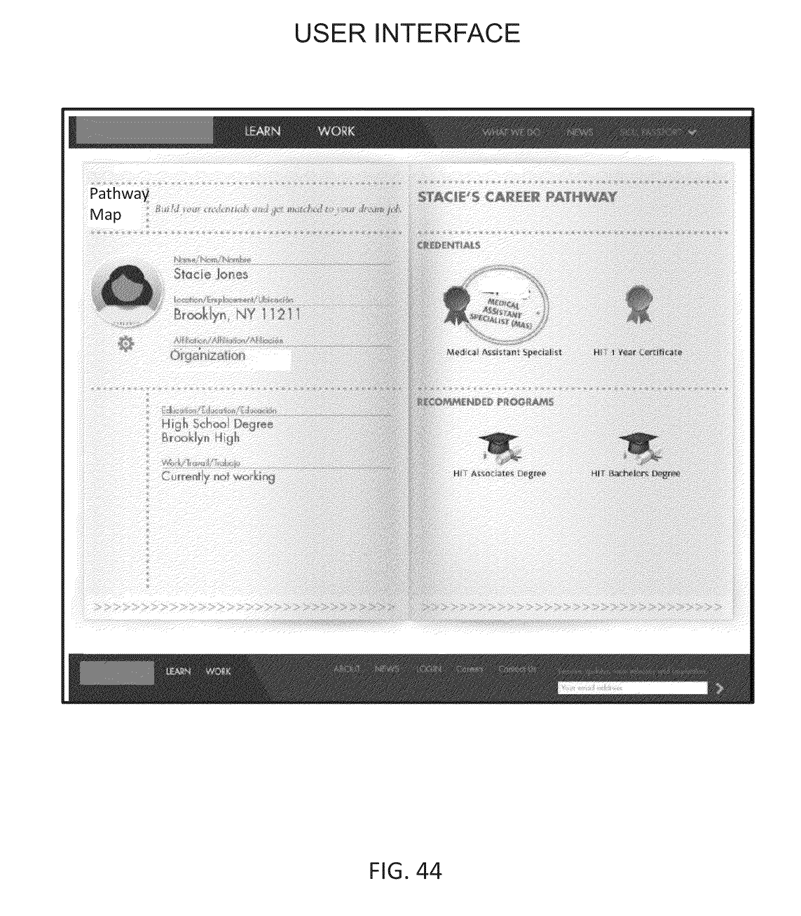

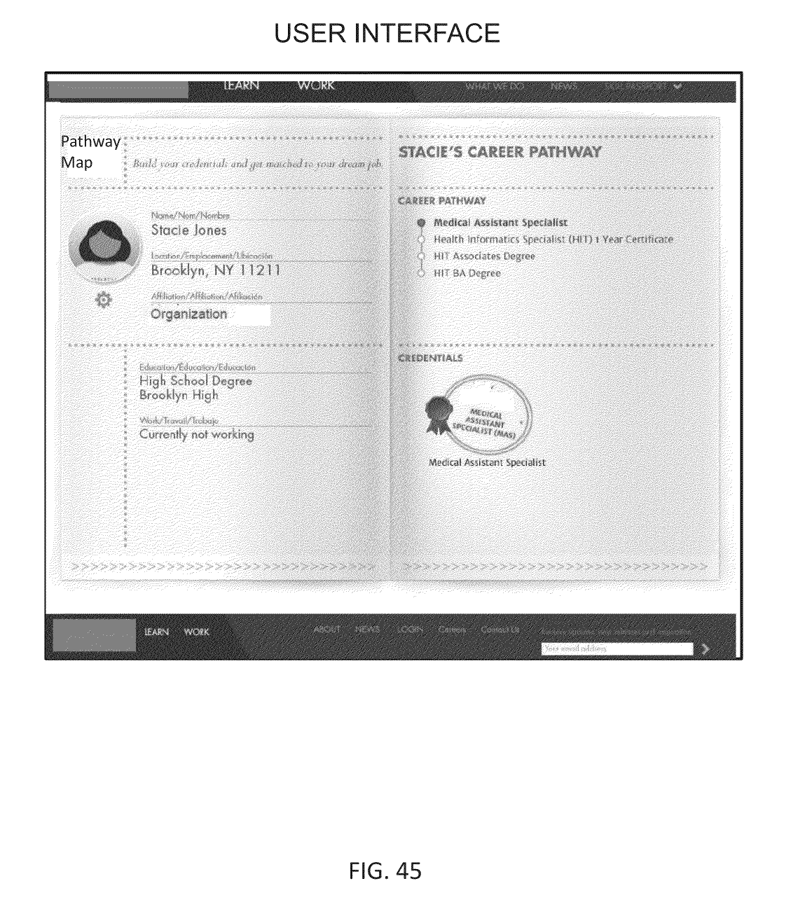

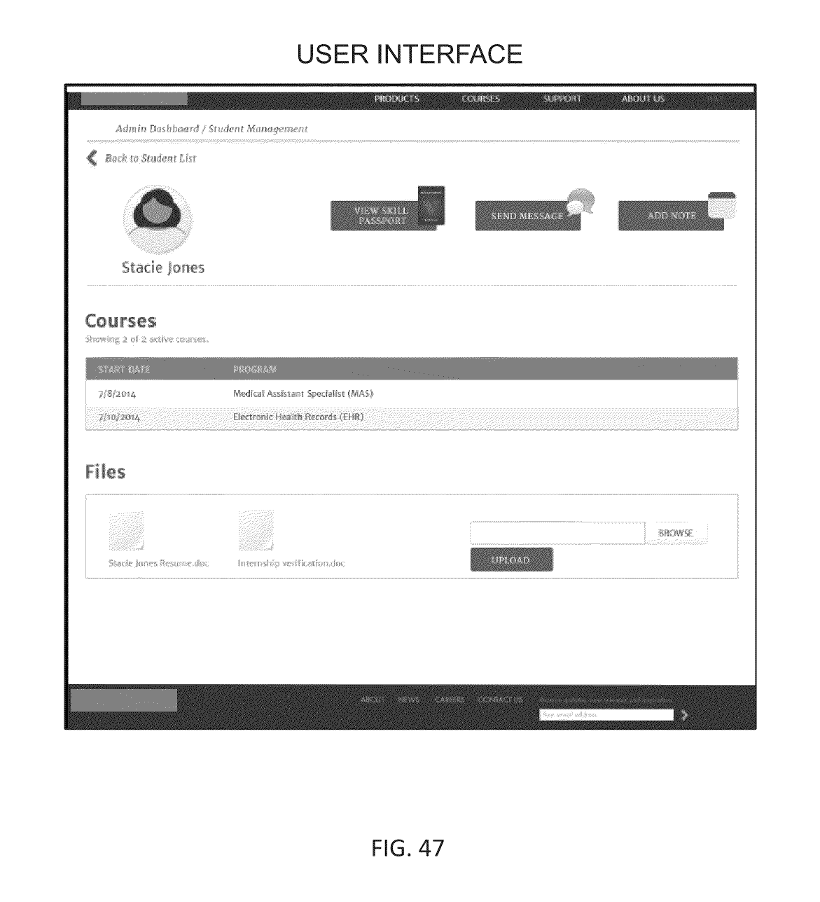

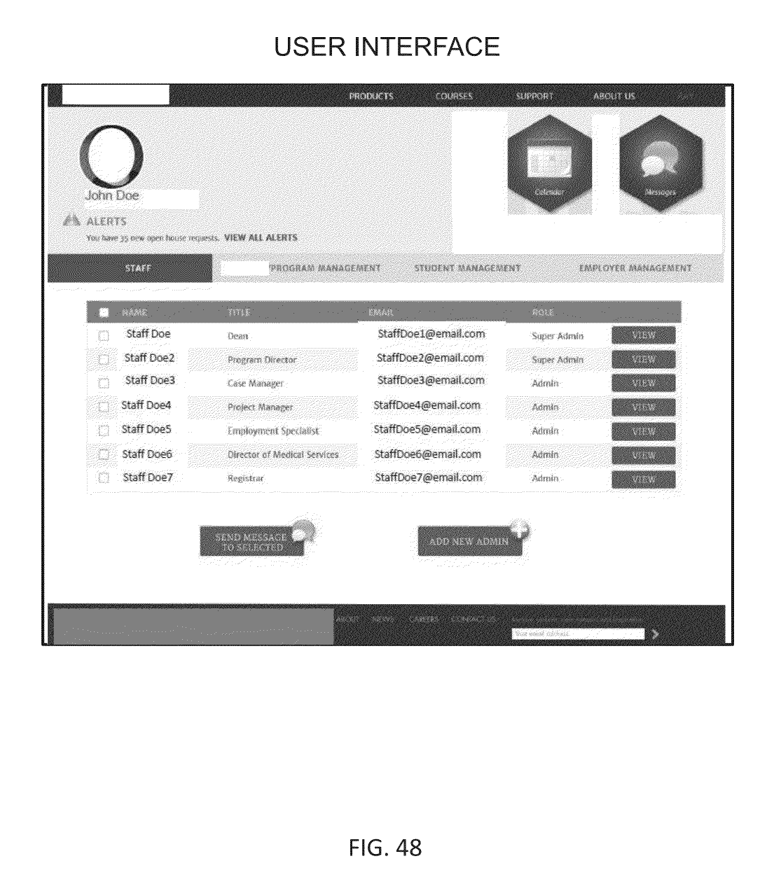

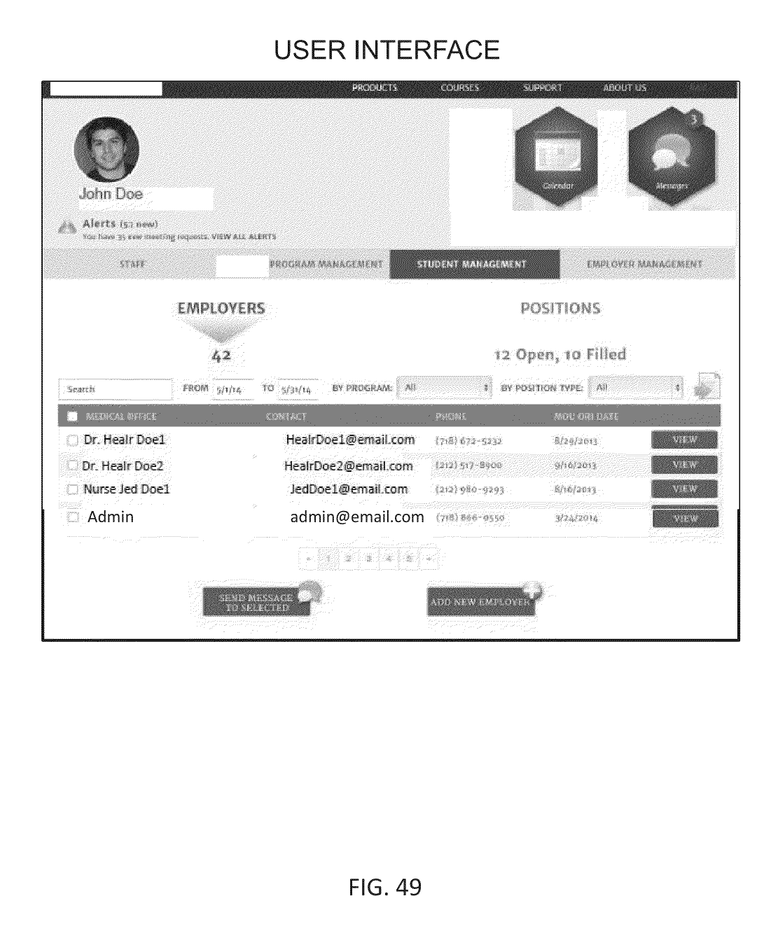

FIGS. 32-51 show other non-limiting example displays of example L ser interfaces (including GUIs) of other example implementations of an apparatus and system, where candidate user input data can be entered, and output results can be displayed. For example, the output results can be displayed to the individual who is following the career path map, or to another person or entity (with the consent of the individual). Any example systems and apparatus described herein can be sued to implement a coursework recommendation tool, a career pathway recommendation tool (including a job matching tool), and an employability score generator, of the example platform.

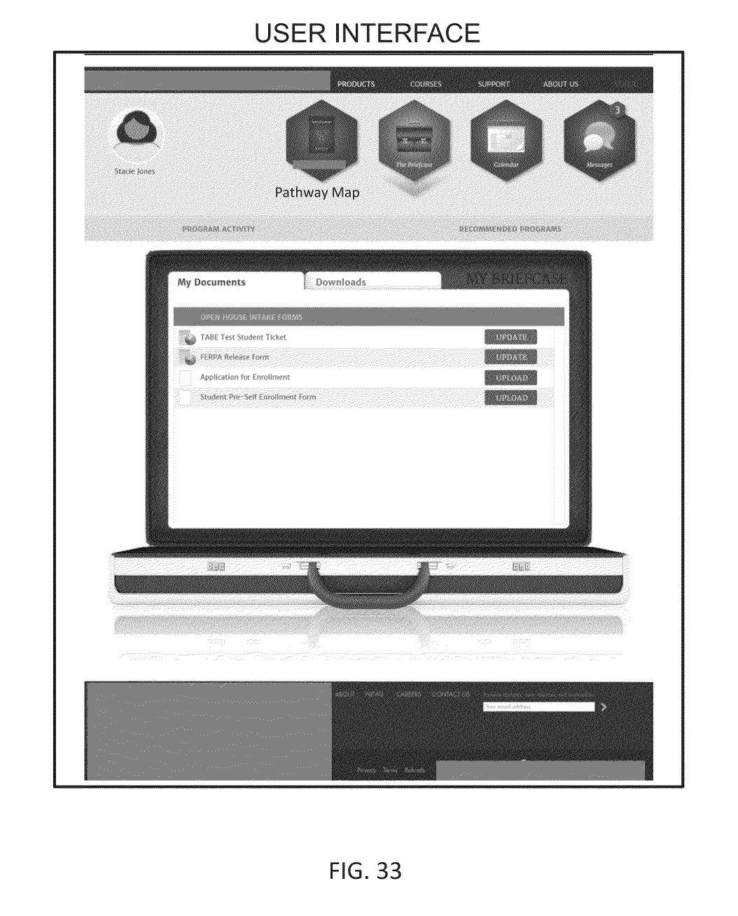

FIG. 32 shows an example user interface that serves as a student dashboard. FIG. 33 shows a user interface that acts as an access portal to a repository of the individual's data, and facilitates real-time communication between the individual and system administrators and/or potential employers.

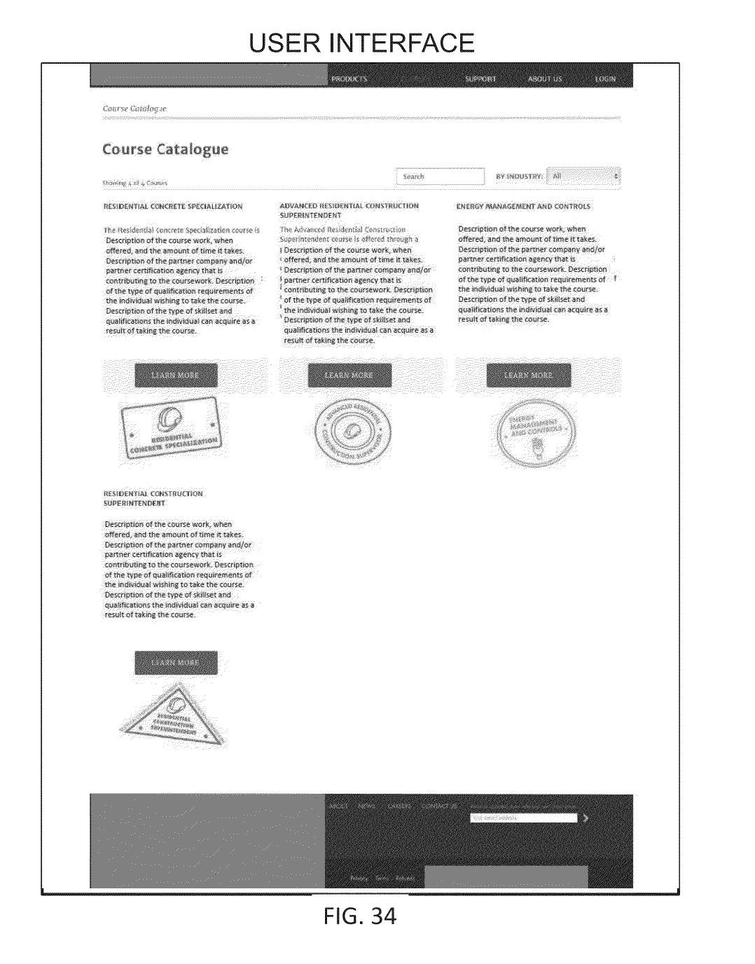

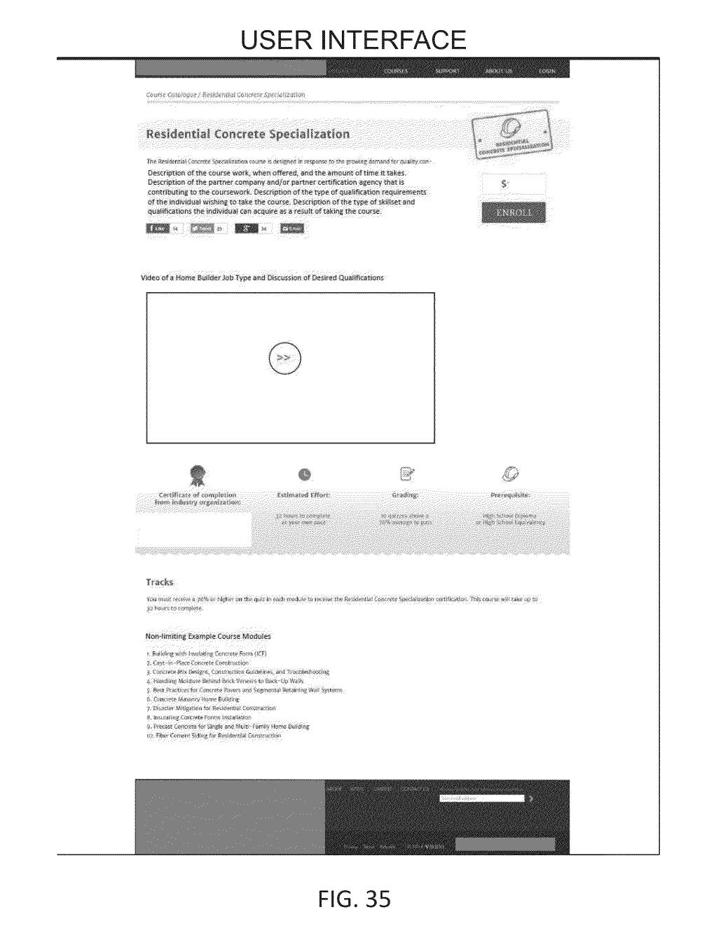

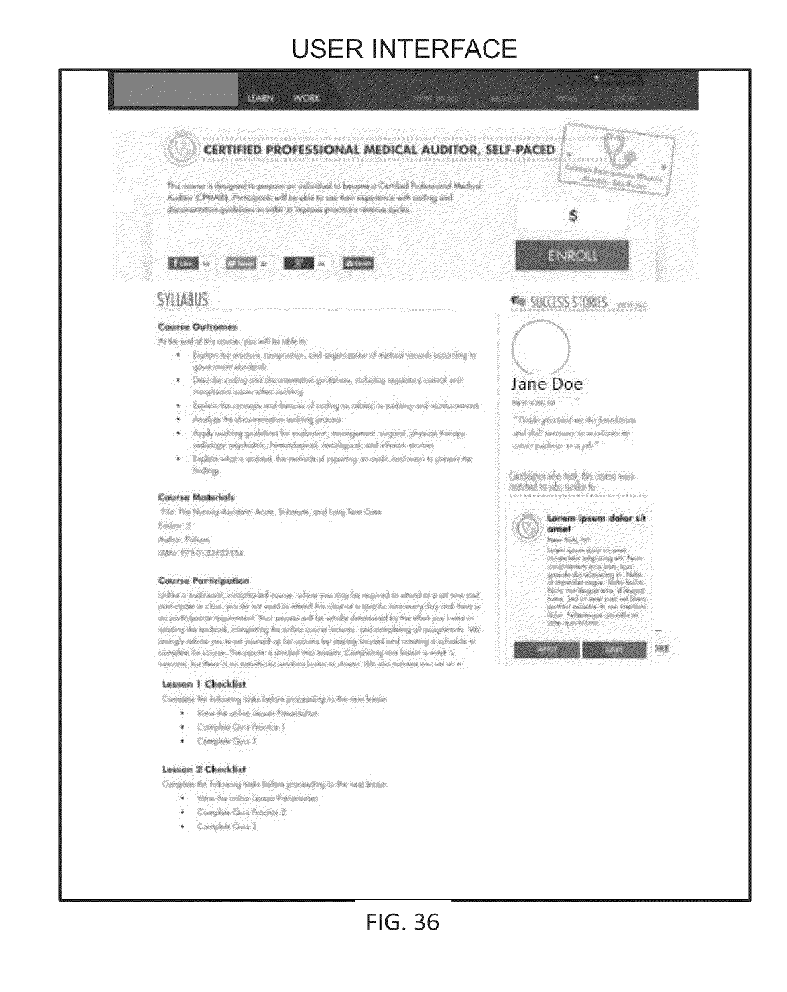

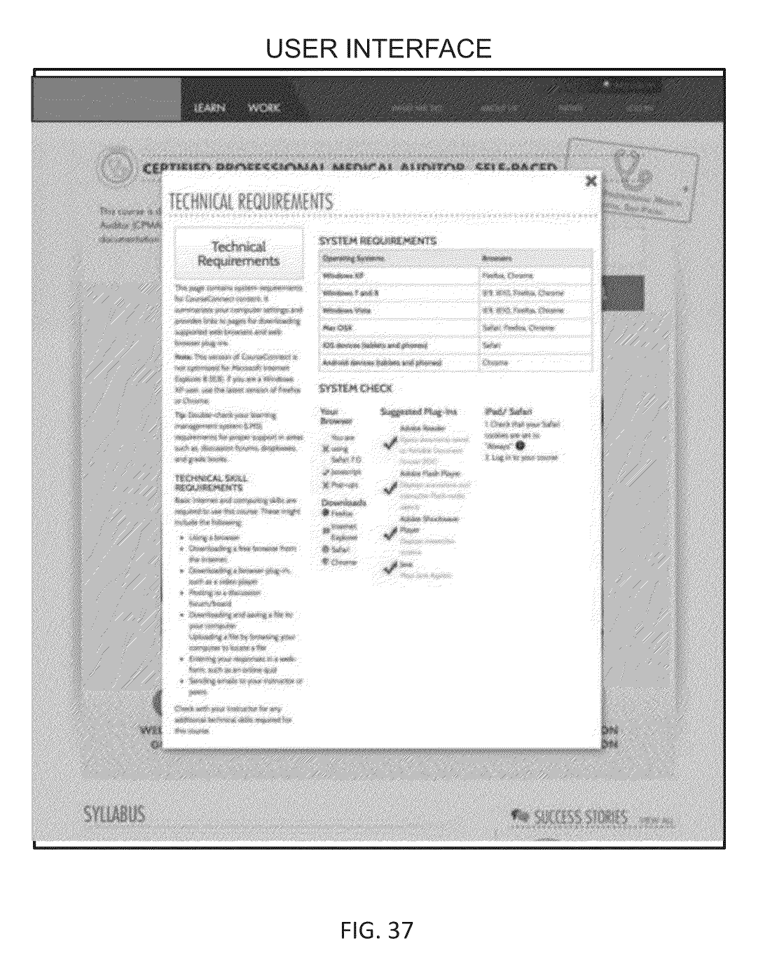

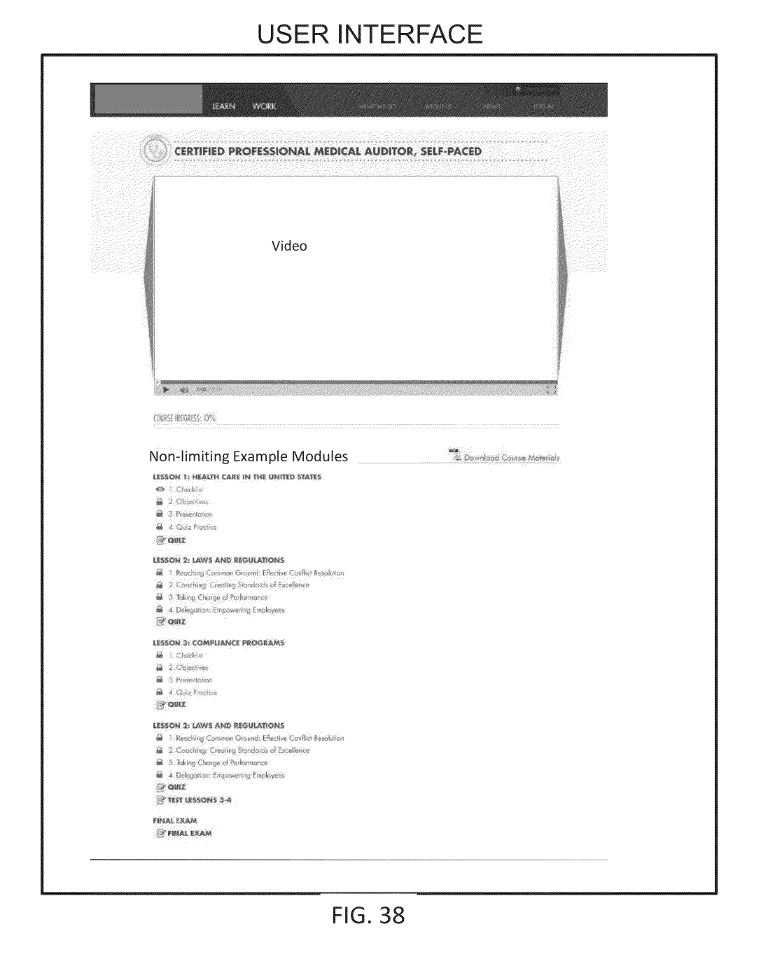

FIGS. 34-38 show example user interfaces with course data. In an example, the coursework can be based on the education services provided by an education services company, such as but not limited to educational materials by Pearson PLC (London, UK) and Pearson Inc., New York, NY. For example, a user interface can be configured to display data in connection with an educational or educational institution course catalogue (FIG. 34), and/or information about specific courses (FIGS. 35-36). As shown in FIG. 37, the example system and apparatus can be configured to provide a pop-up, at the prompting of the individual, with additional information about a career pathway (such as but not limited to technical requirements), for a type of job. FIG. 38 shows non-limiting example educational and/or vocational modules and/or example audio-visual information (e.g., a video) that the example system and apparatus can be configured to display to an individual.

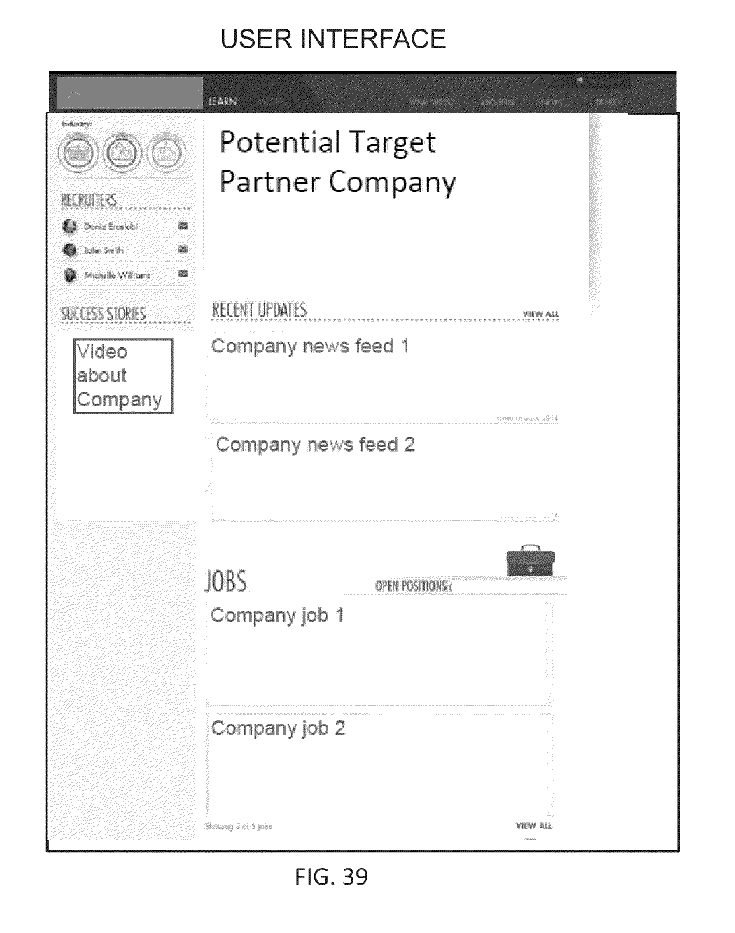

FIG. 39 shows an example user interface for a target company that an example system and apparatus can be configured to display to an individual based on the classification described hereinabove. As shows in FIG. 39, the user interface can be used to display information about the company (e.g., news feeds and videos) and/or job opportunities. In an example, the user interface can provide an employer profile that is generated by the target company,

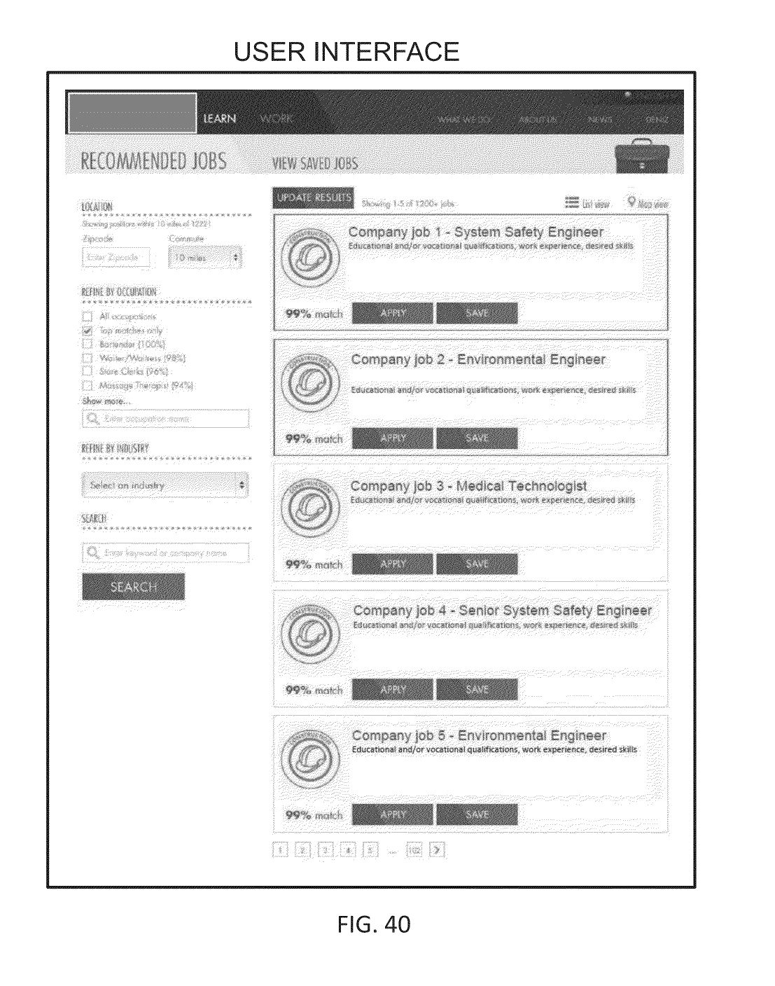

FIG. 40 shows an example of a user interface that an example system and apparatus can be configured to display to show candidate job recommendations to an individual, based on the analysis of the received data associated with the individual, and/or the classification of the individual according to at least one of a coursework recommendation, a career pathway recommendation, and an employability score. As shown in FIG. 40, each job recommendation can be displayed along with a description of the educational and/or vocational qualifications, work experience, and desired skills specified by the candidate employer.

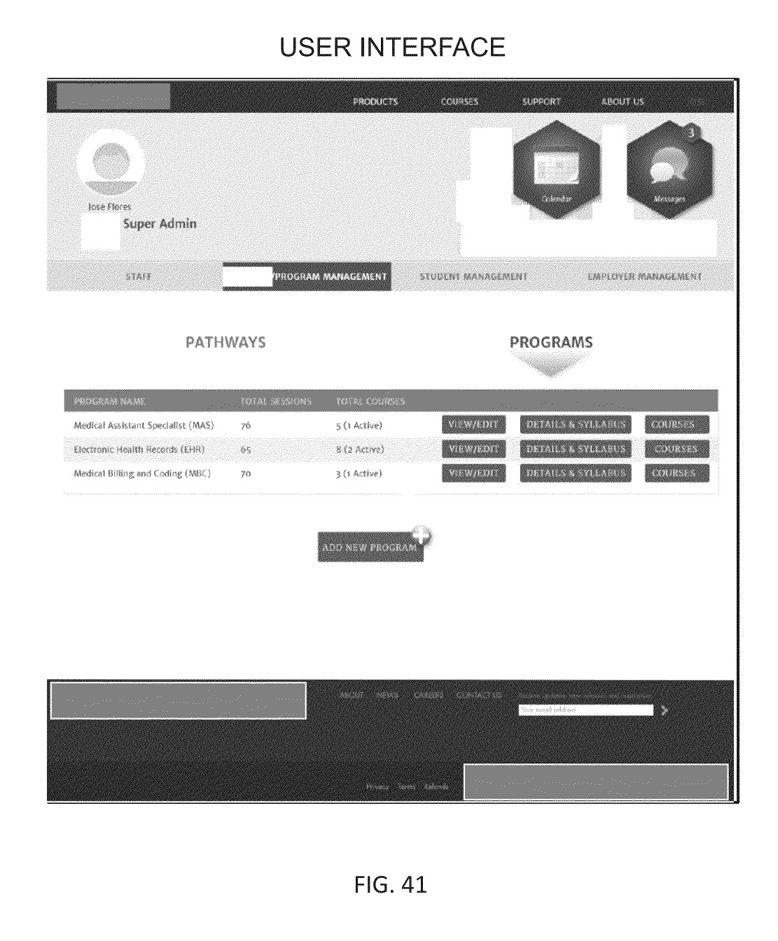

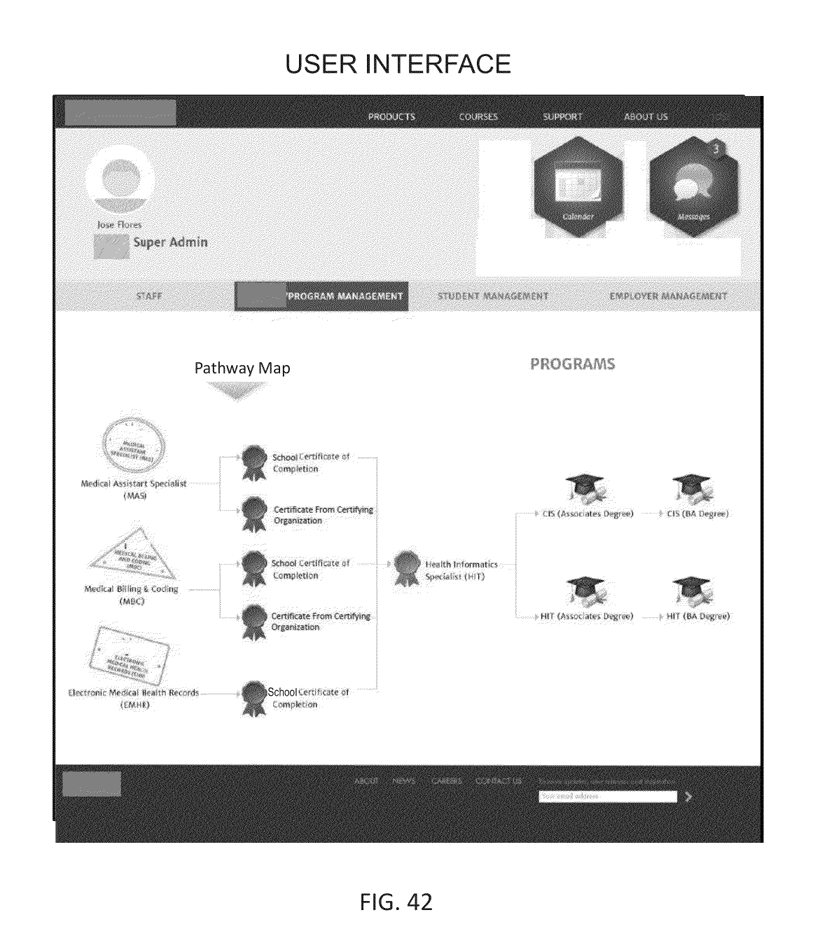

FIGS. 41-42 show examples of user interfaces that a program administrator can use, with consent, to track an individual's process on the career pathway map. For example, the programs being followed by the individual and the pathway maps can be displayed.

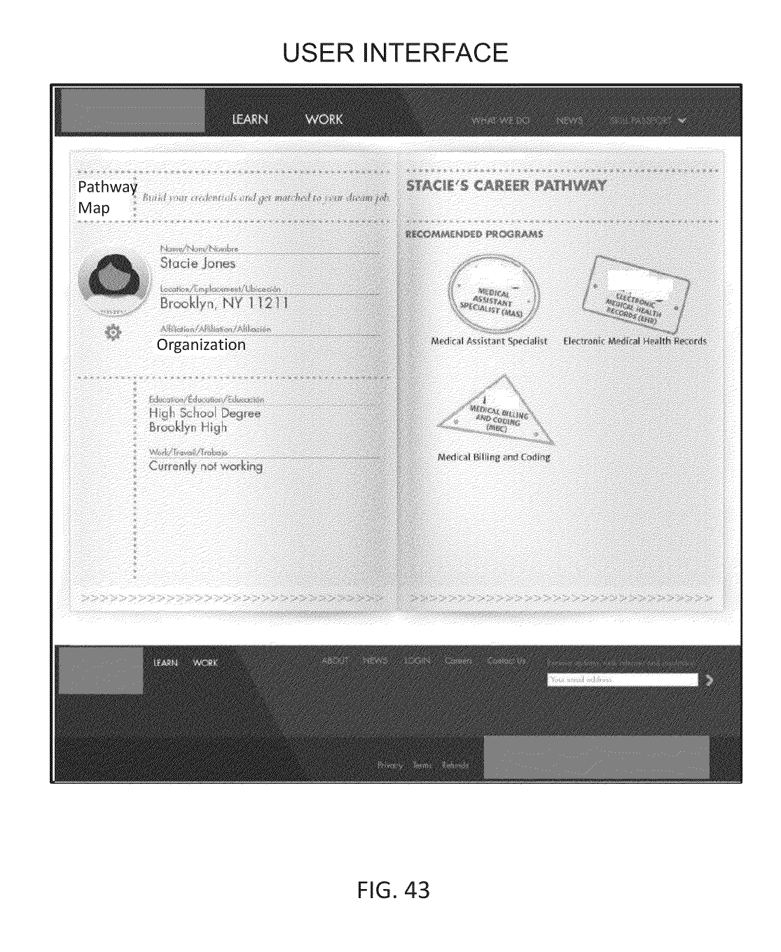

FIGS. 43-45 show examples of user interfaces that an example system or apparatus can be configured to display to an individual as the individual progresses along the generated pathway map. Data indicative of the recommended programs, credentials to be awarded, and career pathway can be displayed based on the generated pathway map.

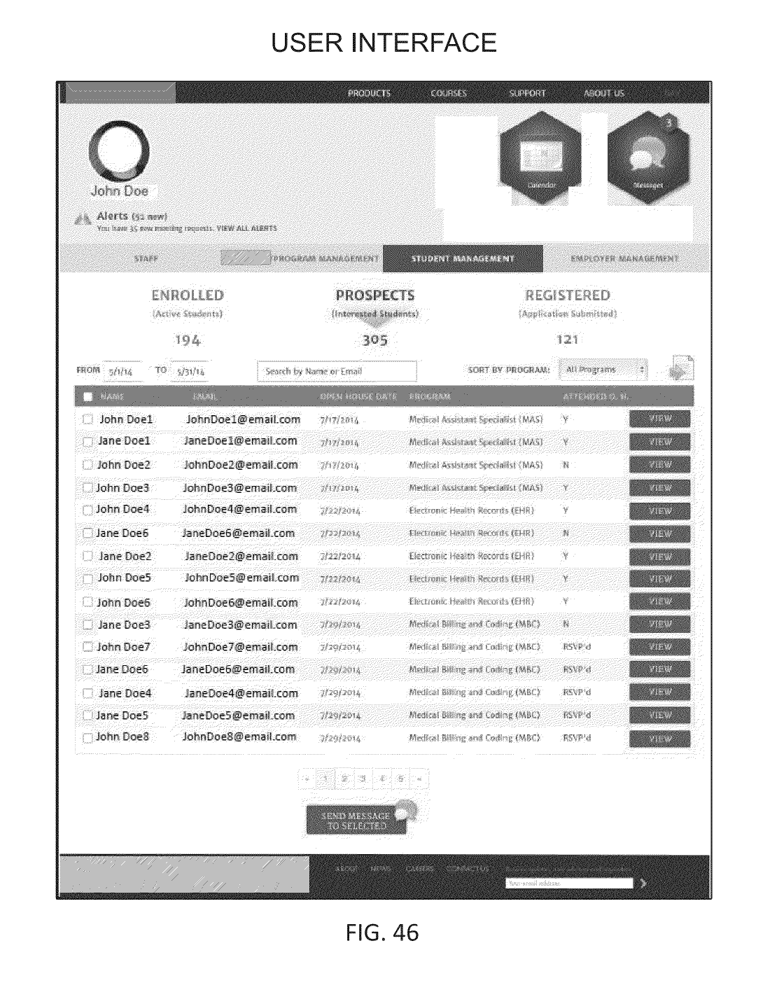

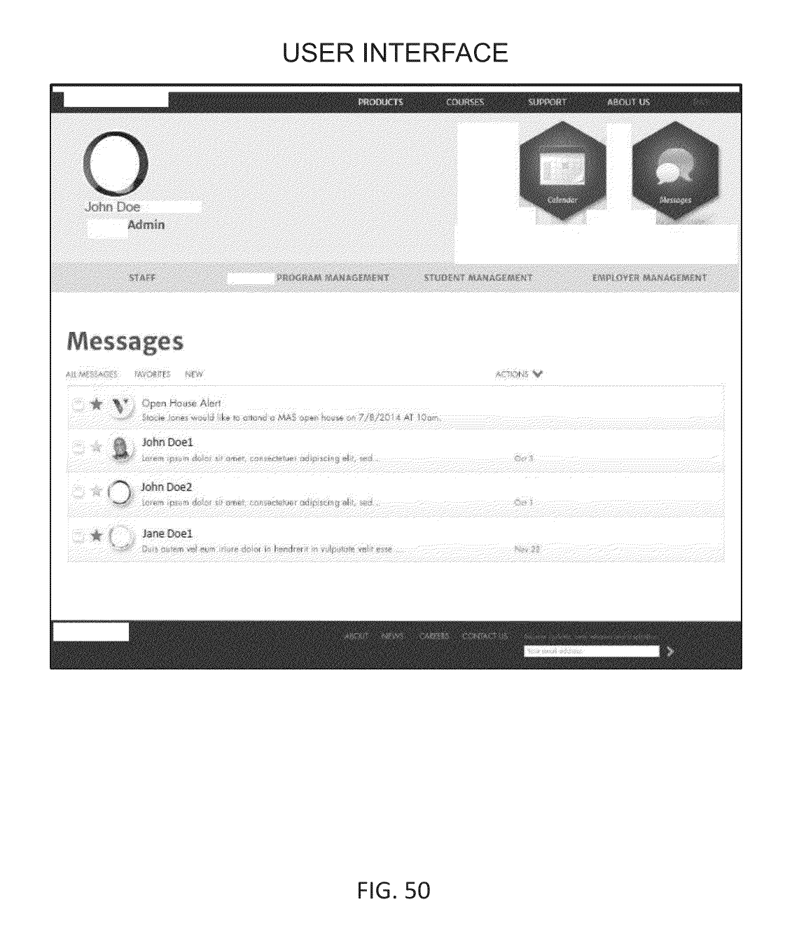

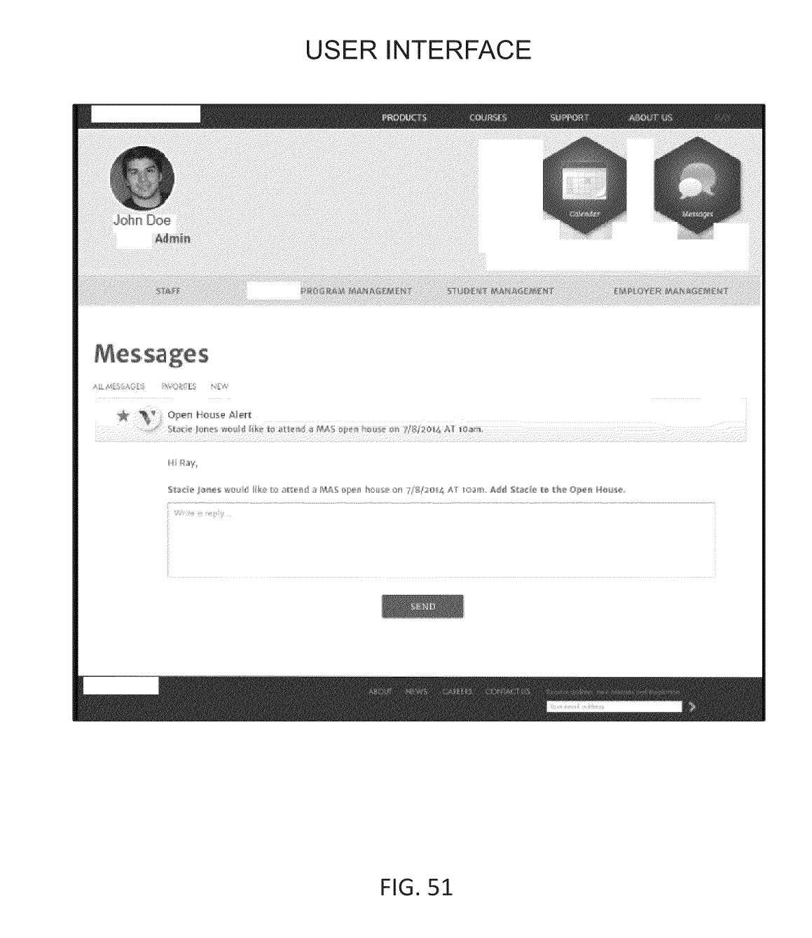

FIGS. 50-51 show examples of user interfaces that an example system or apparatus can be configured to display to one or more administrators of the program, such as but not limited to an administrator of an educational and/or vocational program (FIGS. 46-48), or an administrator of a potential employer, interview coordinator, or recruitment organization.

FIGS. 50-51 show examples of user interfaces that an example system or apparatus can be configured to display to an individual to facilitate real-time communication with one or more administrators (including in the form of messages).

In another non-limiting example implementation, Apps on computing devices can be used to provide a communication interface with the example systems and apparatus described herein, and/or to perform one of more of the analyses and classifications according to the principles described herein.

In the non-limiting example implementations described, the Apps are configured to run an App for use on an iOS® operating system, an Android® operating system, a Windows® operating system, or a Blackberry® operating system. In an example, the App can be used with an internet-connected hand-held computing device (such as but not limited to a, iPhone®, iPad®, or iPad® mini) operating the iOS® operating system. In an example, the App can be used with an internet-connected hand-held computing device (such as but not limited to a Samsung Galaxy® smartphone or tablet) operating the Android® operating system,

### CONCLUSION

While various inventive embodiments have been described and illus rated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention may be implemented in any of numerous ways, including through implementations provided in FIGS. 1-51 attached hereto. For example, some embodiments may be implemented using hardware, software or a combination thereof. When any aspect of an embodiment is implemented at least in part in software, the software code may be executed on any suitable processor or collection of processors, whether provided in a single device or computer or distributed among multiple devices/computers.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification, unless clearly indicated to the contrary, should be understood to mean “at least one.”

The phrase “and/or,” as used herein in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only, terms clearly indicated to the contrary, such as “only one of” or “exactly one of,” or “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B): in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While this specification contains many specific implementation details, these should not be construed as limitations on the scope of any inventions or of what may be claimed, but rather as descriptions of features specific to particular embodiments of the systems and methods described herein. Certain features that are described in this specification in the context of separate embodiments can also be implemented in combination in a single embodiment, Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. An apparatus for generating an adaptive career pathway for an individual, the apparatus comprising:
at least one communication interface:
at least one memory to store processor-executable instructions: and
at least one processing unit, communicatively coupled to the at least one communication interface and the at least one memory, wherein upon execution of the processor-executable instructions, the at least one processing unit:
A) receives data indicative of two or more of an educational level, a skill level, a personality metric, a residence location, a score in an educational course, a score in a vocational course, a job location, and a skill set selected by the individual;
B) computes an assessment vector associated with the individual based on the received data;
C) performs a GAP analysis to compare the assessment vector to a database of job taxonomy vectors, wherein each job taxonomy vector comprises data indicative of deconstruction parameters associated with a specified job:
D) classifies the individual, based on the GAP analysis, according to at least one of a coursework recommendation, a career pathway recommendation, and an employability score; and
E) controls the at least one communication interface to transmit a result of the classification, and/or controls the memory to store the result of the classification.

2. The apparatus of claim 1, wherein the deconstruction parameters are generated based on assessment vector from a plurality of known individuals, wherein the plurality of known individuals include a first set of individuals that retained the specified job for longer than a probationary period.

3. The apparatus of claim 2, wherein the plurality of known individuals include a second set of individuals that retained the specified job for longer than a probationary period.

4. The apparatus of claim 1, wherein the at least one communication interface transmits the result of the classification to at least one of the individual and a system administrator.

5. The apparatus of claim 1, wherein the at least one communication interface facilitates real-time communication between the individual and the system administrator.

6. The apparatus of claim 1, wherein the at least one processing unit classifies the individual according to the coursework recommendation by identifying educational courses and/or vocational courses, recommending a sequence of taking the educational courses and/or the vocational courses, and providing an expected score for at least of the educational courses and/or the vocational courses.

7. The apparatus of claim 6, wherein the at least one processing unit determines a deviation of the individual's actual score for the at least of the educational courses and/or the vocational courses from the expected score, and wherein the deviation indicates poor performance of the individual.

8. The apparatus of claim 7, wherein the at least one processing unit provides an alert of the deviation to at least one of the individual and a system administrator.

9. The apparatus of claim 7, wherein the expected score is a grade point average.

10. The apparatus of claim 1, wherein in A), the at least one processing unit further receives pre-enrollment data, and wherein the pre-enrollment data is data associated with the individual prior to enrollment in an educational course and/or an vocational course.

11. The apparatus of claim 1, wherein the at least one processing unit further receives data indicative of a job performance of the individual based on the career pathway recommendation.

12. The apparatus of claim 11, wherein in the at least one processing unit generates deconstruction parameters associated with the specified job based on the data indicative of a job performance of the individual.

13. A graphical user interface (GUI) for facilitating generation of an adaptive career pathway for an individual, the GUI comprising:
two or more graphical interface pages arranged in a hierarchical format or a navigable format, the two or more graphical interface pages including:
A) at least one graphical interface page to receive input data indicative of two or more of an educational level, a skill level, a personality metric, a residence location, a score in an educational course, a score in a vocational course, a job location, and a skill set selected by the individual; and
B) at least one graphical interface page to display data indicative of a classification of the individual according to at least one of a coursework recommendation, a career pathway recommendation, and an employability score,
wherein the classification is based on a GAP analysis comparing:
(i) an assessment vector associated with the individual, computed based on the received data, and
(ii) a database of job taxonomy vectors, each job taxonomy vector comprising data indicative of deconstruction parameters associated with a specified job.

14. The GUI of claim 13, wherein the two or more graphical interface pages include at least one graphical interface page to display the result of the classification to at least one of the individual and a system administrator.

15. The GUI of claim 14, wherein the at least one graphical interface page to display the result of the classification facilitates real-time communication between the individual and the system administrator.

16. The GUI of claim 14, wherein the two or more graphical interface pages include at least one graphical interface page to display to at least one of the individual and a system administrator, at least one of: a recommended educational course, a recommended vocational course, a recommended sequence of taking an educational course and/or a vocational course, and an expected score for at least of an educational course and/or a vocational course.

17. The apparatus of claim 16, wherein the two or more graphical interface pages include at least one graphical interface page to display to at least one of the individual and a system administrator data indicative of a deviation of the individual's actual score for at least of the educational course and the vocational course from the expected score, and wherein the deviation indicates poor performance of the individual.

18. An apparatus for generating an adaptive career pathway for an individual, the apparatus comprising:
at least one communication interface;
an assessment module to compute an assessment vector associated with the individual based on received data, the received data comprising data indicative of two or more of an educational level, a skill level, a personality metric, a residence location, a score in an educational course, a score in a vocational course, a job location, and a skill set selected by the individual;
an analysis module to apply a GAP analysis to compare the assessment vector to a database of job taxonomy vectors, wherein each job taxonomy vector comprises data indicative of deconstruction parameters associated with a specified job; and
a classification module to classify the individual, based on the GAP analysis, according to at least one of a coursework recommendation, a career pathway recommendation, and an employability score.

19. The apparatus of claim 18, wherein the deconstruction parameters are generated based on assessment vector from a plurality of known individuals, wherein the plurality of known individuals include a first set of individuals that retained the specified job for longer than a probationary period.

20. The apparatus of claim 19, wherein the plurality of known individuals include a second set of individuals that retained the specified job for longer than a probationary period.

21. The apparatus of claim 18, wherein the classification module classifies the individual according to the coursework recommendation by identifying educational courses and/or vocational courses, recommending a sequence of taking the educational courses and/or the vocational courses, and providing an expected score for at least of the educational courses and/or the vocational courses.

22. The apparatus of claim 21, wherein the classification module determines a deviation of the individual's actual score for the at least of the educational courses and/or the vocational courses from the expected score, and wherein the deviation indicates poor performance of the individual.

23. The apparatus of claim 22, further comprising a communication module to:
(i) display data indicative of the result of the classification to at least one of the individual and a system administrator; and/or
(ii) facilitates real-time communication between the individual and the system administrator; and/or
(iii) display data indicative of the deviation to at least one of the individual and a system administrator.
